(19) United States
(12) Patent Application Publication
(10) Pub. No.: US 2025/0167844 A1
(43) Pub. Date: May 22, 2025

(54) SIGNALING FOR HYBRID BEAMFORMING IN OPEN-RAN

(71) Applicant: Samsung Electronics Co., Ltd., Suwon-si (KR)

(72) Inventors: Xinliang Zhang, Plano, TX (US); Young Han Nam, Plano, TX (US); Shouvik Ganguly, Frisco, TX (US); Vitali Loseu, Plano, TX (US)

(21) Appl. No.: 18/893,897

(22) Filed: Sep. 23, 2024

Related U.S. Application Data
(60) Provisional application No. 63/601,583, filed on Nov. 21, 2023.
(60) Provisional application No. 63/603,481, filed on Nov. 28, 2023.

(51) Int. Cl. H04B 7/06

(52) U.S. Cl. CPC H04B 7/0617

(57) ABSTRACT

For an O-RAN system, supported hybrid beamforming configurations are indicated based on a number of analog ports, a number of digital ports, a number of analog ports per transceiver, and supported codebooks. A hybrid beamforming configuration to be employed includes control bit vectors for phase-shifters, each control bit vector mapped to a phase value, an in-phase (I) value and a quadrature (Q) value. The hybrid beamforming configuration may include analog and digital beamforming parameters applicable to frequency bands or subbands or joint phase-time array parameters.

### CROSS-REFERENCE TO RELATED APPLICATION AND PRIORITY CLAIM

This application claims priority under 35 U.S.C. § 119(e) to U.S. Provisional Patent Application No. 63/601,583 filed on Nov. 21, 2023 and U.S. Provisional Patent Application No. 63/603,481 filed on Nov. 28, 2023, the content of which is hereby incorporated by reference.

### TECHNICAL FIELD

This disclosure relates generally to radio access network fronthaul. More specifically, this disclosure relates to hybrid beamforming in open radio access network.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4^{th} Generation (4G) communication systems, and to enable various vertical applications, 5^{th} Generation (5G) communication systems have been developed and are currently being deployed, and 6^{th} Generation (6G) communications systems are being developed.

The 5G communication system is considered to be implemented to include higher frequency (millimeter Wave or “mmWave”) bands, such as 28 giga-Hertz (GHz) or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use Terra-Hertz (THz) bands. To decrease propagation loss of the radio waves and increase the transmission distance, the beamforming (BF), massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-point (CoMP) communication, reception-end interference cancellation, and the like.

In the 5G system, hybrid frequency shift key (FSK) and quadrature amplitude modulation (QAM) modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

### SUMMARY

This disclosure provides, for an O-RAN system, supported hybrid beamforming configurations are indicated based on a number of analog ports, a number of digital ports, a number of analog ports per transceiver, and supported codebooks. A hybrid beamforming configuration to be employed includes control bit vectors for phase-shifters, each control bit vector mapped to a phase value, an in-phase (I) value and a quadrature (Q) value. The hybrid beamforming configuration may include analog and digital beamforming parameters applicable to frequency bands or subbands or joint phase-time array parameters.

In a first embodiment, a method of operating a distributed unit (DU) includes receiving, from a radio unit (RU), first information indicating supported hybrid beamforming (BF) configurations, wherein the first information includes a number of analog ports, a number of digital ports, a number of analog ports per transceiver (TRX), and supported codebooks. The method also includes determining, based on the first information, whether to down-select the supported codebooks. The method further includes generating a hybrid BF configuration and transmitting, to the RU, the hybrid BF configuration. The hybrid BF configuration includes control bit vectors for phase-shifters, where the control bit vectors are mapped to a phase value, an in-phase (I) value and a quadrature (Q) value.

In a second embodiment, a distributed unit (DU) apparatus a transceiver configured to receive, from a radio unit (RU), first information indicating supported hybrid beamforming (BF) configurations, where the first information includes a number of analog ports, a number of digital ports, a number of analog ports per transceiver (TRX), and supported codebooks. The DU apparatus also includes a controller configured to determine, based on the first information, whether to down-select the supported codebooks. The controller is further configured to generate a hybrid BF configuration. The transceiver is configured to transmit, to the RU, the hybrid BF configuration, where the hybrid BF configuration includes control bit vectors for phase-shifters. The control bit vectors are mapped to a phase value, an in-phase (I) value and a quadrature (Q) value.

In a third embodiment, a radio unit (RU) apparatus includes a controller configured to control beamforming. The RU apparatus also includes a transceiver configured to receive, from a distributed unit (DU), first information indicating supported hybrid beamforming (BF) configurations, where the first information includes a number of analog ports, a number of digital ports, a number of analog ports per transceiver (TRX), and supported codebooks. Whether to down-select the supported codebooks is determined by the DU, and a hybrid BF configuration is generated by the DU, based on the first information. The transceiver is configured to receive, from the DU, the hybrid BF configuration, where the hybrid BF configuration includes control bit vectors for phase-shifters. The control bit vectors are mapped to a phase value, an in-phase (I) value and a quadrature (Q) value.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network 100 within which either hybrid beamforming for O-RAN fronthaul or transmission of control information over O-RAN fronthaul for JPTA may be implemented according to embodiments of the present disclosure;

FIGS. 2A and 2B illustrate example wireless transmit and receive paths that may be used in connection with either hybrid beamforming for O-RAN fronthaul or transmission of control information over O-RAN fronthaul for JPTA according to embodiments of the present disclosure;

FIG. 3A illustrates an example UE that may be used in connection with either hybrid beamforming for O-RAN fronthaul or transmission of control information over O-RAN fronthaul for JPTA according to embodiments of the present disclosure;

FIG. 3B illustrates an example gNB 102 that may be used in connection with either hybrid beamforming for O-RAN fronthaul or transmission of control information over O-RAN fronthaul for JPTA according to embodiments of the present disclosure;

FIG. 4 illustrates an example beamforming architecture that may be used in connection with either hybrid beamforming for O-RAN fronthaul or transmission of control information over O-RAN fronthaul for JPTA according to embodiments of the present disclosure;

FIG. 4A illustrates a gNB JPTA architecture, and FIG. 4B illustrates a 2D beam pattern for JPTA discrete-angle beams;

FIG. 5 is a high level block diagram illustrating an example O-RAN architecture that may be used in connection with either hybrid beamforming for O-RAN fronthaul or transmission of control information over O-RAN fronthaul for JPTA according to embodiments of the present disclosure;

FIGS. 6 and 6A are collectively a diagram illustrating an example hybrid beamforming architecture for one layer that may be used in connection with hybrid beamforming for O-RAN fronthaul according to embodiments of the present disclosure;

FIG. 7 is a diagram illustrating an example hybrid beamforming architecture for multiple layers that may be used in connection with hybrid beamforming for O-RAN fronthaul according to embodiments of the present disclosure;

FIG. 8 is a signaling diagram illustrating an example of hybrid beamforming for use in connection with the O-RAN fronthaul according to embodiments of the present disclosure;

FIG. 9 illustrates an example of hybrid weight-based dynamic beamforming configuration that may be used in connection with hybrid beamforming for O-RAN fronthaul according to embodiments of the present disclosure;

FIG. 10 illustrates an example of hybrid CSI-based beamforming configuration that may be used in connection with hybrid beamforming for O-RAN fronthaul according to embodiments of the present disclosure;

FIG. 11 illustrates an example of a mapping from the hybrid beam ID to an analog beam group ID and a digital beam ID according to embodiments of the present disclosure;

FIG. 12 is a signaling diagram illustrating an alternative example of hybrid beamforming for use in connection with the O-RAN fronthaul according to embodiments of the present disclosure;

FIG. 13 illustrates an example of an alternative mapping from the hybrid beam ID to an analog beam group ID and a digital beam ID according to embodiments of the present disclosure;

FIG. 14 illustrates an example of C-plane hybrid beamforming configuration with digital beamforming weights according to embodiments of the present disclosure;

FIG. 15 illustrates an example of C-plane hybrid beamforming configuration with analog and digital beamforming weights according to embodiments of the present disclosure;

FIG. 16 illustrates an example of C-plane hybrid beamforming configuration with analog and digital beamforming weights according to embodiments of the present disclosure;

FIG. 17 is a signaling diagram illustrating an example of fronthaul processing steps for use in connection with the O-RAN fronthaul for JPTA according to embodiments of the present disclosure; and

FIG. 18 is a high level flowchart of a process of hybrid beamforming configuration in accordance with embodiments of the present disclosure.

### DETAILED DESCRIPTION

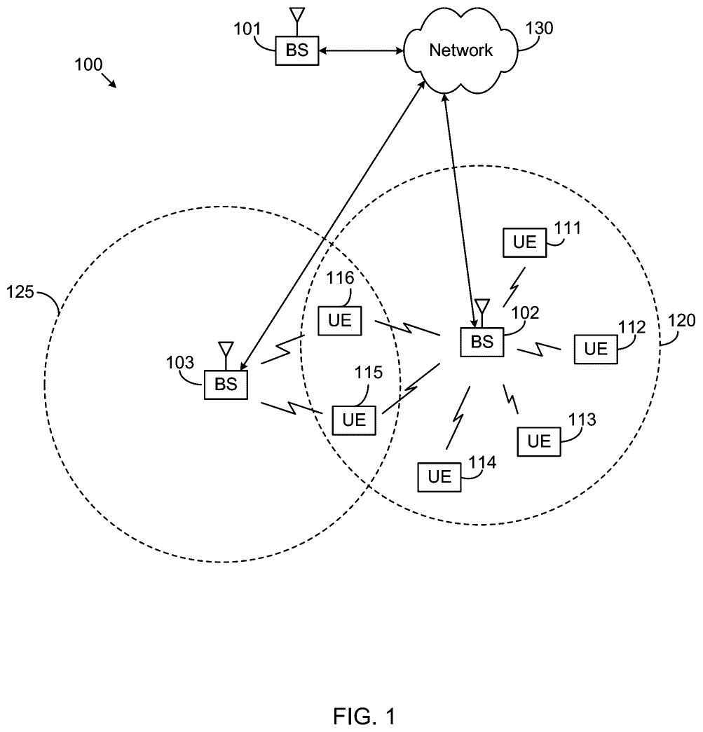

FIGS. 1 through 18, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

The following references are incorporated herein by reference:
[1]O-RAN Working Group 4 (Open Fronthaul Interfaces WG), “Control, User and Synchronization Plane Specification”, O-RAN.WG4.CUS.0-R003-v13.00.
[2]I. Jain, et al., “Towards Flexible Frequency-Dependent mmWave Multi-Beamforming” International Workshop on Mobile Computing Systems and Applications (HotMobile '23), 2023, doi:10.1145/3572864.3581579.
[3]V. V. Ratnam et al., “Joint Phase-Time Arrays: A Paradigm for Frequency-Dependent Analog Beamforming in 6G,” in IEEE Access, vol. 10, pp. 73364-73377, 2022, doi: 10.1109/ACCESS.2022.3190418.
[4]V. Boljanovic et al., “Fast Beam Training with True-Time-Delay Arrays in Wideband Millimeter-Wave Systems,” in IEEE Transactions on Circuits and Systems I: Regular Papers, vol. 68, no. 4, pp. 1727-1739, April 2021, doi: 10.1109/TCSI.2021.3054428.
[5]A. Alammouri et al., “Extending Uplink Coverage of mmWave and Terahertz Systems Through Joint Phase-Time Arrays,” in IEEE Access, vol. 10, pp. 88872-88884, 2022, doi: 10.1109/ACCESS.2022.3200334.

Open Radio Access Network (O-RAN) is a standard that governs protocol between a distributed unit (DU) and a radio unit (RU). O-RAN Split Option 7-2× Category B is used for massive multiple input, multiple output (MIMO) products, where the signals on compressed data streams are conveyed through the fronthaul rather than the all-antenna-port signals.

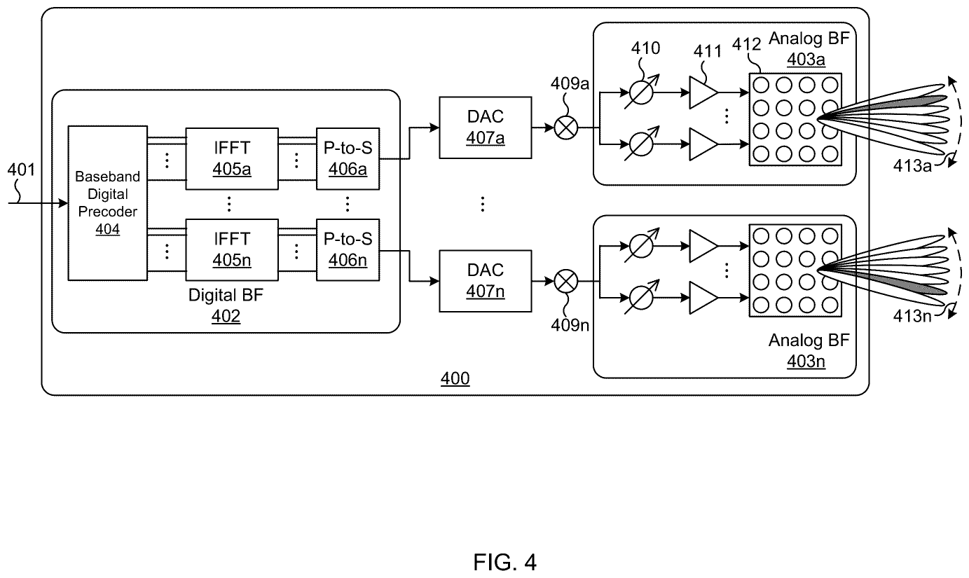

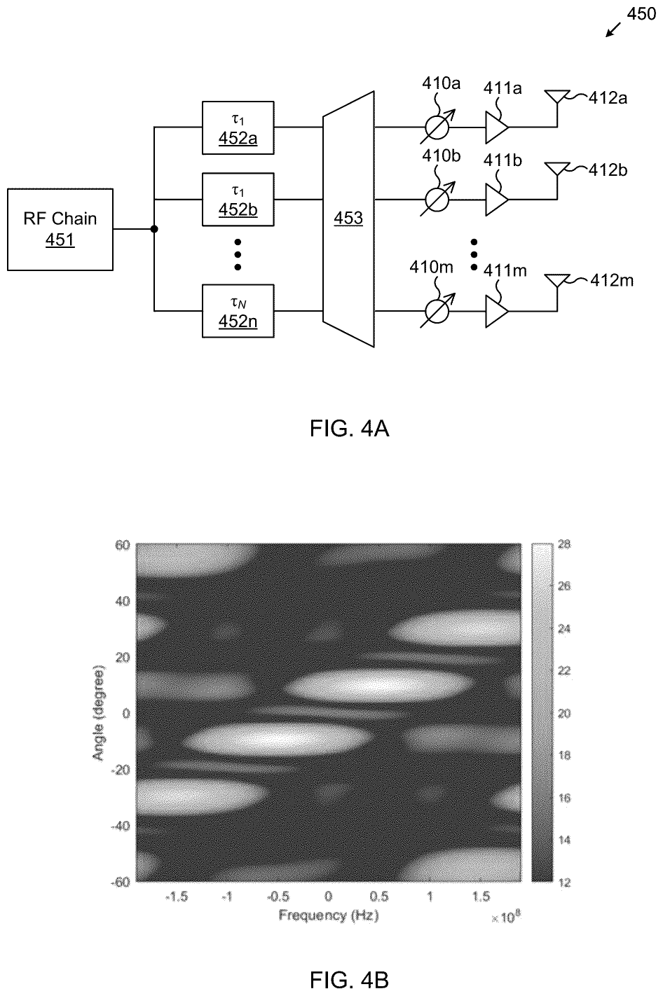

A new beamforming and frequency multiplexing radio frequency frontend architecture, called joint phase-time arrays (JPTA), has been gaining popularity recently as a potential technology for 5G and 6G. A JPTA network consists of phase shifters and delay units, as shown in FIG. 4A, and allows the transceivers to perform frequency-dependent beamforming, enabling multiple UEs at different spatial locations to be served on distinct sets of resource blocks (PRBs), with relatively high beam gain and low inter-UE interference. An example of JPTA beam pattern is shown in FIG. 4B, where a JPTA beam is designed to serve UEs at angles −30°, −15°, 15°, 30°. UEs at different angles observe the maximum beam gain over distinct sets of frequency bands or RBs, allowing the BS to multiplex the data for all of these users without causing inter-user interference and without sacrificing the beam gain for some of the UEs. Different algorithms have been proposed to design the JPTA beam (the set of phases and delays needed to configure the JPTA radio frequency network) as in [2, 3] and the potential performance gains have been also studied in [4, 5].

FIGS. 1-2 and 3A-3B depict various embodiments implemented in wireless communications systems according to embodiments of the present disclosure. The descriptions of FIGS. 1-2 and 3A-3B are not meant to imply physical or architectural limitations to how different embodiments may be implemented. Different embodiments of the present disclosure may be implemented in any suitably arranged communications system.

FIG. 1 illustrates an example wireless network 100 within which either hybrid beamforming for O-RAN fronthaul or transmission of control information over O-RAN fronthaul for JPTA may be implemented according to embodiments of the present disclosure. The embodiment of the wireless network 100 shown in FIG. 1 is for illustration only. Other embodiments of the wireless network 100 can be used without departing from the scope of this disclosure.

As shown in FIG. 1, the wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of gNB 101, gNB 102 and gNB 103 include includes circuitry, programing, or a combination thereof, to support signalling for hybrid beamforming between DU and RU in a O-RAN network.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

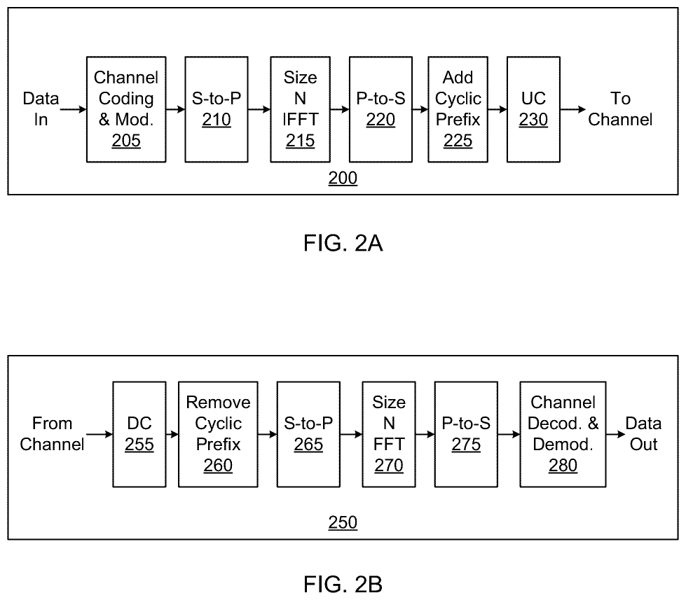

FIGS. 2A and 2B illustrate example wireless transmit and receive paths that may be used in connection with either hybrid beamforming for O-RAN fronthaul or transmission of control information over O-RAN fronthaul for JPTA according to embodiments of the present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with quadrature phase shift keying (QPSK) or QAM) to generate a sequence of frequency-domain modulation symbols. The serial-to-parallel block 210 converts (such as de-multiplexes) the serial modulated symbols to parallel data in order to generate N parallel symbol streams, where N is the inverse fast Fourier transform/fast Fourier transform (IFFT/FFT) size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. In the receive path 250, the down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as discrete Fourier transform (DFT) and inverse discrete Fourier transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

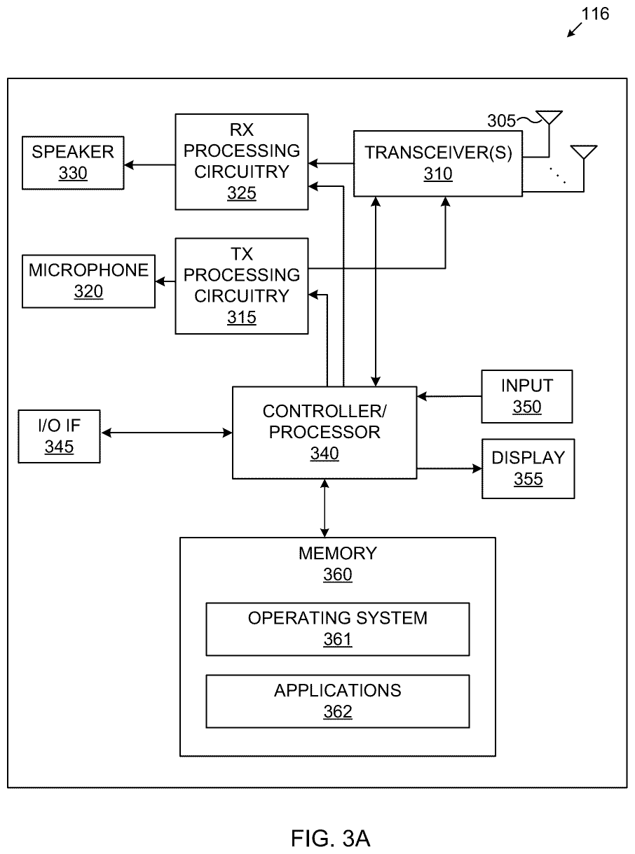

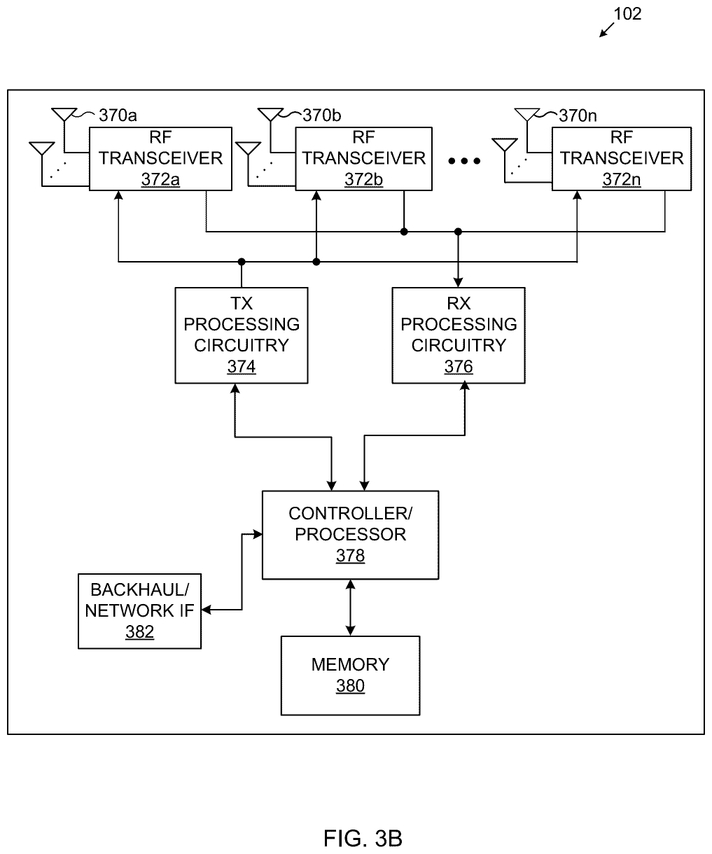

FIG. 3A illustrates an example UE that may be used in connection with either hybrid beamforming for O-RAN fronthaul or transmission of control information over O-RAN fronthaul for JPTA according to embodiments of the present disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the wireless network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

FIG. 3B illustrates an example gNB 102 that may be used in connection with either hybrid beamforming for O-RAN fronthaul or transmission of control information over O-RAN fronthaul for JPTA according to embodiments of the present disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting signalling for hybrid beamforming between DU and RU within the gNB 102, as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of frequency division duplex (FDD) cells and time division duplex (TDD) cells.

Although FIG. 3B illustrates one example of an gNB 102, various changes may be made to FIG. 3B. For example, the gNB 102 can include any number of each component shown in FIG. 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Rel.13 LTE supports up to 16 channel state information reference signal (CSI-RS) antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports remain more or less the same.

FIG. 4 illustrates an example beamforming architecture that may be used in connection with either hybrid beamforming for O-RAN fronthaul or transmission of control information over O-RAN fronthaul for JPTA according to embodiments of the present disclosure. The embodiment of the beamforming architecture 400 shown in FIG. 4 is for illustration only. FIG. 4 does not limit the scope of this disclosure to any particular implementation of a beamforming architecture. It is noted that the beamforming architecture 400 or a similar structure may be implemented within any of gNB 101, gNB 102, and/or gNB 103 in FIG. 1. It is noted that the beamforming architecture 400 or a similar structure may be implemented within any of RF transceiver 372a, RF transceiver 372b, and/or RF transceiver 372n in FIG. 3B.

The beamforming architecture 400 receives input signal(s) 401 corresponding to signals to the transmitted. The beamforming architecture 400 includes digital beamforming circuitry 402 and a plurality of instances of analog beamforming circuitry 403a-403n. The digital beamforming circuitry 402 includes a baseband digital precoder 404 that receives the input signal(s) 401 and outputs signals for a number of circuitry chains corresponding to the number of CSI-RS ports. Each of those circuitry chains includes an instance of an IFFT block 405a-405n and an instance of a parallel-to-serial block 406a-406n. The outputs of those circuit chains within the digital beamforming circuitry 402 are passed to a corresponding DAC 407a-407n, the outputs of which are passed via a mixer 409a-409n to one of the instances of analog beamforming circuitry 403a-403n. Each instance of the analog beamforming circuitry 403a-403n includes a plurality of circuit chains including an analog phase shifter 410 and a power amplifier (PA) 411 connected in series to each other and to an array 412 of antenna elements. Each instance of the analog beamforming circuitry 403a-403n transmits on at least one beam within a plurality of beams 413a-413n.

For mmWave bands, although the number of antenna elements can be larger for a given form factor, the number of CSI-RS ports—which can correspond to the number of digitally precoded ports—tends to be limited due to hardware constraints (such as the feasibility to install a large number of analog-to-digital converters (ADCs)/digital-to-analog converters (DACs) at mmWave frequencies) as illustrated by beamforming architecture 400 in FIG. 4. In this case, one CSI-RS port is mapped onto a large number of antenna elements, which can be controlled by a bank of analog phase shifters 410. One CSI-RS port can then correspond to one sub-array producing a narrow analog beam through analog beamforming 403a-403n. This analog beam can be configured to sweep across a wider range of angles (encompassed by beams 413a, beams 413n, etc.) by varying the phase shifter bank across symbols or subframes or slots (where a subframe or a slot comprises a collection of symbols and/or can comprise a transmission time interval (TTI)). The number of sub-arrays (equal to the number of RF chains) is the same as the number of CSI-RS ports N_{CSI-PORT}. The digital beamforming circuitry 402 performs a linear combination across N_{CSI-PORT} analog beams to further increase precoding gain. While analog beams are wideband (hence not frequency-selective), digital precoding can be varied across frequency sub-bands or resource blocks.

FIG. 4A illustrates a gNB JPTA architecture 450 with one RF chain and a single phase-shifter per antenna element, which may be used in conjunction with the beamforming architecture 400. An RF chain 451 may include the digital beamforming circuitry 402 and DACs 407a-407n. The analog beamforming circuitry includes a plurality (N) of adjustable delay units 452a, 452b, . . . , 452n coupled to a switching circuit 453. The outputs of the switching circuit 453 are passed to M adjustable phase shifters 410a, 410b, . . . , 410m each connected to a PA 411a, 411b, . . . , 411m and an antenna element 412a, 412b, . . . , 412m. FIG. 4B illustrates a 2D beam pattern for JPTA discrete-angle beams, where the angles {−30, −15, 15, 30} are associated with distinct bundles of subcarriers that provide high beam gain.

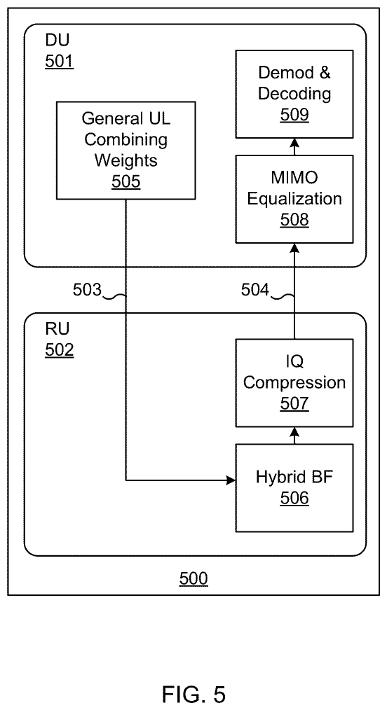

FIG. 5 is a high level block diagram illustrating an example O-RAN architecture that may be used in connection with either hybrid beamforming for O-RAN fronthaul or transmission of control information over O-RAN fronthaul for JPTA according to embodiments of the present disclosure. The embodiment of the O-RAN architecture 500 shown in FIG. 5 is for illustration only. FIG. 5 does not limit the scope of this disclosure to any particular implementation of a O-RAN architecture.

The O-RAN architecture 500 includes a DU 501 and an RU 502 coupled by a control (C) plane 503 and a user (U) plane 504. Uplink (UL) signal flows within the DU 501, within the RU 502, and across the DU 501 and the RU 502 according to some embodiments of the existing O-RAN specification will be understood by those skilled in the art. For example, the O-RAN architecture 500 may be implemented within any of gNB 101, gNB 102, and/or gNB 103 in FIG. 1. For simplicity and clarity, the complete structure and operation of an O-RAN system is not depicted or described herein. Instead, only so much of an O-RAN system as is necessary for an understanding of the present disclosure is depicted and described.

For UL in hybrid beamforming MIMO, the DU 501 generates general UL spatial combining weights 505 (a/k/a, a spatial compression matrix). The UL spatial combining weights 505 are generated per sub-band, per data stream. For example, the UL spatial combining weights 505 may be a 16×256 complex matrix (wherein 16 corresponds to the number of data streams (or layers) and 256 corresponds to the number of transceiver units at the RU). The UL spatial combining weights 505 are sent to the RU 502 via the C-plane 503 of the O-RAN protocol. Then, the RU 502 applies spatial compression on the 256 port received signals on each resource element, by multiplying the UL spatial combining weights 505 to the 256 port received signals in hybrid beamforming 506. Then, these 16 data streams are compressed 507, e.g., using block floating (in-band and quadrature (IQ)) compression, and sent to the DU 501 over O-RAN U-plane 504. The DU 501 performs MIMO equalization 508 on the signals received from the RU 502, and then performs demodulation and decoding 509.

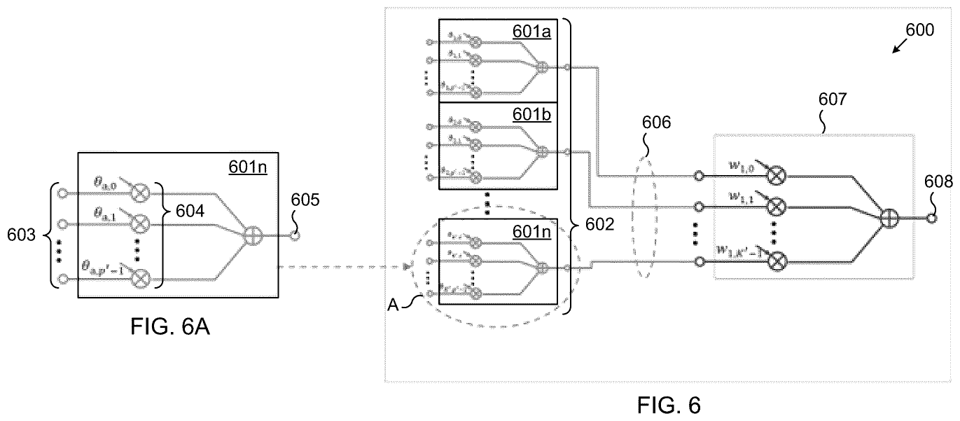

FIGS. 6 and 6A are collectively a diagram illustrating an example hybrid beamforming architecture for one layer that may be used in connection with hybrid beamforming for O-RAN fronthaul according to embodiments of the present disclosure. The embodiment of the hybrid beamforming architecture 600 shown in FIGS. 6 and 6A is for illustration only. FIGS. 6 and 6A do not limit the scope of this disclosure to any particular implementation of a hybrid beamforming architecture. In addition, the hybrid beamforming architecture 600 may be implemented for any of the layers corresponding to the N_{CSI-PORT} CSI-RS ports described above.

The hybrid beamforming architecture 600 in FIGS. 6 and 6A includes a plurality of subarrays 601, 601b, . . . , 601n collectively implementing analog (time domain) beamforming 602. An enlarged view of one of the subarrays 601n in FIG. 6 is provided in FIG. 6A. The hybrid beamforming architecture 600 has a total of K analog ports 603 across the subarrays 601a, 601b, . . . , 601n, K phase-shifters 604, and K′ digital ports 605. Accordingly, each subarray 601a, 601b, . . . , 601n includes p′=K/K′ of the total analog ports 603 and of the total phase-shifters 604. Within each subarray 601n, the phase value θ_{a,b} is used for the subarray having index a and the analog port having index b. The outputs (digital ports 605) of the subarrays 601a, 601b, . . . , 601n are coupled to K′ transceivers 606 (TRX, not graphically depicted), each providing one input to digital (frequency domain) beamforming 607. For the single layer hybrid beamforming architecture 600 of FIG. 6, one of a group of weights w₀, . . . , w_{k′-1} is applied to the respective input to the digital (frequency domain) beamforming 607, where 0, . . . , k′−1 is the index of the one of the transceivers 606 coupled to the respective input.

In practice, the MIMO RU hybrid beamforming architecture 600 depicted in FIG. 6 can perform hybrid beamforming in the uplink that contains both digital spatial combining and analog spatial combining with K analog ports 603 to K′ transceivers 606 and to one layer at an output 608.

The analog beamforming 602 processes the received analog signal(s) in the time domain. The K analog ports 603 are combined to K′ transceivers 606, as shown in FIG. 6, on the left side of the K′ transceivers 606. The K analog ports 603 each has a configurable phase-shifter. The K analog ports are divided into K′ subarrays 601a, 601b, . . . , 601n. Within each subarray 601n, the p′=K/K′ analog ports 603 are phased-shifted and combined to one digital port, i.e., the input to the corresponding transceiver 606. In total, K phase-shifter values for K phase-shifters 604 are related in a certain time interval, e.g., a symbol, a slot, etc. The digital beamforming 607 processes the signal on the K′ transceivers 606 in frequency domain.

In some embodiments, all the K phase-shifter values are configured for analog BF.

In some embodiments, an analog beam identifier (ID) is associated with each of the p′ phase-shifter values for the p′ phase shifters 604 in the subarray 601n. The mapping between the analog beam ID and the phase-shifter values can be hard-coded in the RU, or configured by the DU.

In some embodiments, an analog beam group ID is associated with the K′ analog beam IDs or K phase-shifter values. Such mappings can be hardcoded in the RU or configured by the DU. By configuring the analog beam group ID, the analog beamforming is settled.

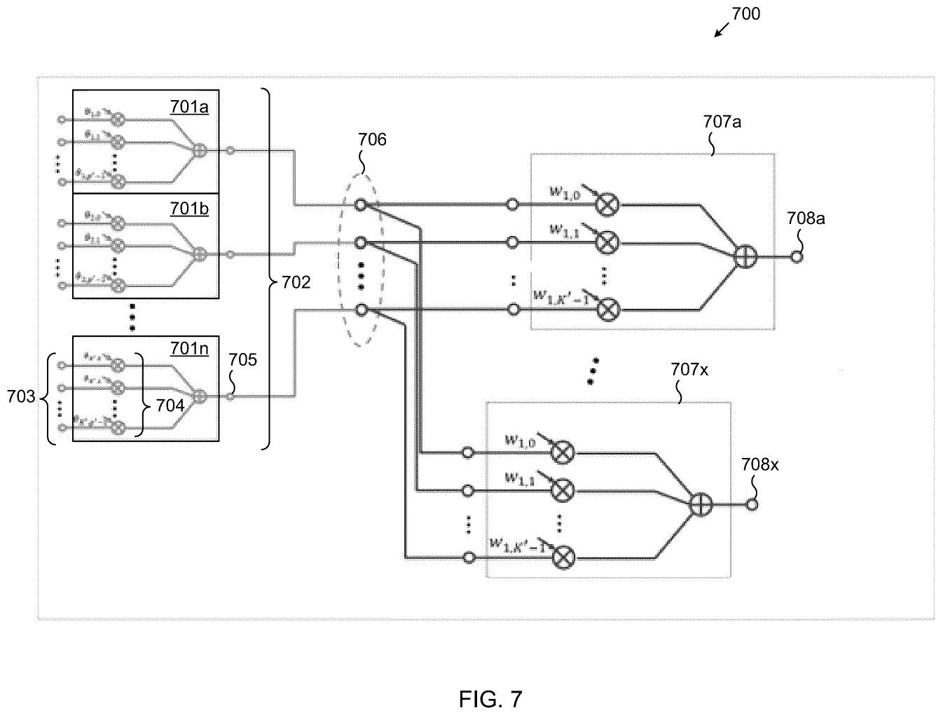

FIG. 7 is a diagram illustrating an example hybrid beamforming architecture for multiple layers that may be used in connection with hybrid beamforming for O-RAN fronthaul according to embodiments of the present disclosure. The embodiment of the hybrid beamforming architecture 700 shown in FIG. 7 is for illustration only. FIG. 7 does not limit the scope of this disclosure to any particular implementation of a hybrid beamforming architecture.

The hybrid beamforming architecture 700 in FIG. 7 includes a plurality of subarrays 701, 701b, . . . , 701n collectively implementing analog (time domain) beamforming 702. The hybrid beamforming architecture 700 has a total of K analog ports 703 across the subarrays 701a, 701b, . . . , 701n, K phase-shifters 704, and K′ digital ports 705. Accordingly, each subarray 701n includes p′=K/K′ of the total analog ports 703 and of the total phase-shifters 704. Within each subarray 701n, the phase value θ_{a,b} is used for the subarray having index a and the analog port having index b. The outputs (digital ports 705) of the subarrays 701a, 701b, . . . , 701n are coupled to K′ transceivers 706 (not graphically depicted), each providing one input to digital (frequency domain) beamforming 707a, . . . , 707x. For the multiple layer hybrid beamforming architecture 700 of FIG. 7, one of a group of weights w_{l,0}, . . . , w_{l,k′-1} is applied to the respective input to the digital (frequency domain) beamforming 707a, . . . , 707x, where l is the index of one of the L layers and 0, . . . , k′−1 is the index of the one of the transceivers 706 coupled to the respective input. The single layer digital beamforming architecture 600 shown in FIG. 6 includes a single instance of the digital beamforming 607 on the right side of the K′ transceivers 606. The weights (w₀, . . . , w_{k′-1}) combine the signal on the K′ transceivers 606 to one layer, on output 608. In the multiple (e.g., L) layer hybrid beamforming architecture 700 shown in FIG. 7, a similar group of K′ transceivers 706 contribute to each of the layers. Each layer is produced by K′ digital beamforming weights (w_{l,0}, . . . , w_{l,k′-1}) and transmitted on one of the outputs 708a, . . . , 708x.

In some embodiment, the K′*L digital beamforming weights are configured to establish the digital beamforming.

In some embodiment, L digital beam IDs are configured, with each digital beam ID mapped to a certain group of digital beamforming weights. The mapping can be hard-coded in the RU, or configured by the DU.

In some embodiment, the digital beamforming is configured per subband. In each subband, the digital beamforming weights can be different from the other subband. Less sub-bandwidth benefits the granularity and receiver signal-to-information-and-noise ratio (SINR); large sub-bandwidth benefits the fronthaul traffic and computational efficiency.

The total parameter to be configured in the hybrid beamforming includes K phase-shifter values for analog beamforming and K′ weights per layer per subband for digital beamforming.

In the C-plane, the controlling message is defined in the O-RAN Control, User, and Synchronization Planes (CUS-planes) Specification as Section Types (ST). There are six predefined STs in which ST1, ST3, ST4, and ST5 are designed for uplink spatial combining configurations, e.g., ST1 is for DL/UL radio channels requiring time or frequency offsets, ST3 is for channels requiring time or frequency offsets, and ST5 is for UE scheduling information. Commonly, all ST1, ST3, and ST5 contains the frame, sub-frame, slot, range of symbols, and range of physical resource blocks (PRBs) to which the spatial combining will be applied. Besides the ST, section extensions (SE) may be used to transfer extra information. For example, SE 1, SE 2, and SE 11 are designed for beamforming weights, beamforming attribute, and flexible beamforming weights transfer.

Examples of hybrid beamforming configuration signaling in the O-RAN specification include:
1. ST1+SE1: The digital and analog beamforming configurations are transferred together in one section description. The K′ digital beamforming weights and K analog beamforming weights are formed in in-phase and quadrature (I/Q) values. Each section description of ST1 with SE1 contains hybrid beamforming weights for one data layer and one subband.
2. ST1+SE11: The digital and analog beamforming configuration are transferred together in one section description. The K′ digital beamforming weights and K analog beamforming weights are formed in I/Q values. Each section description of ST1 with SE1 contains hybrid beamforming weights for one data layer and multiple subbands.
3. ST1+SE1 and ST4: The digital and analog beamforming configurations are transferred separately in ST1+SE1 and ST4. The K′ digital beamforming weights are formed in I/Q values in ST1+SE1 per layer and per subband. An analog beam group ID, K′ 15-bit analog beam IDs, and K analog beamforming weights are formed in I/Q value and are transferred in ST4 per slot.
4. ST5+SE10+SE1: The user equipment (UE) IDs (ueld) are configured through ST5+SE10, the RU performs channel state information (CSI) based beamforming (CIBF) for the digital beamforming. The analog beamforming configuration is contained in SE1 with K I/Q values for the phase-shifters per time interval described in ST5.

However, the following problems exist in the current O-RAN specification:
1. In all the hybrid beamforming configurations in the O-RAN specification, the format of the analog phase shifter configuration is fixed as configuring in-phase and quadrature (I/Q) values. However, the limited format is not practical for a phase shifter configuration that works in a codebook-based manner.
2. In all the hybrid beamforming configurations in the O-RAN specification, the bit-width of the analog beam ID is fixed as 15 bits by the O-RAN specification. However, 15 bits is redundant for RU designs with states much less than 215.
3. The O-RAN existing hybrid BF configuration methods have limitations: The SE1 with SE1 or SE11 repeatedly transferring the same analog BF config. The redundancy is huge for massive MIMO and more redundant information will be transferred than the necessary information.

The present disclosure addresses these identified problems as follows:
The DU transfers control bit vectors for the phase shifters in the RU, instead of as I/Q values.
The DU transfers bit width reduced analog beam IDs, instead of 15 bits.
The bit width of the control bit vectors and beam IDs are configured through the management plane (M-plane) from the RU to the DU.
The bit width reduced hybrid beamforming configuration can be achieved in SE or configuring the analog beamforming in a separate ST.
The on/off for beamforming weights/beam ID of analog/digital beamforming can be supported to minimize the redundancy in the message.
Compression of the analog beamforming weights can be dynamically configured in the C-plane, separately from the digital beamforming.
The mapping between overall beam ID to digital beam ID and analog beam group ID can be established through the M-plane or the C-plane. The digital or analog BF configuration can be derived at the RU.

According to an embodiment, the RU reports the hybrid BF related configuration and codebooks to the DU through the M-plane. Except when the codebook exists in the O-RAN specification, extra codebooks are transferred in some embodiments, such as: 1) a codebook of analog phase shifter values to control bit vectors mapping, 2) a codebook of the analog beam IDs to phase shifter values per TRX mapping, etc. Such codebooks also indicate the bit width of the control bit vectors and beam IDs. The bit width is directly used in the C-plane messages or repeatedly mentioned in the C-plane messages for RU implementation convenience.

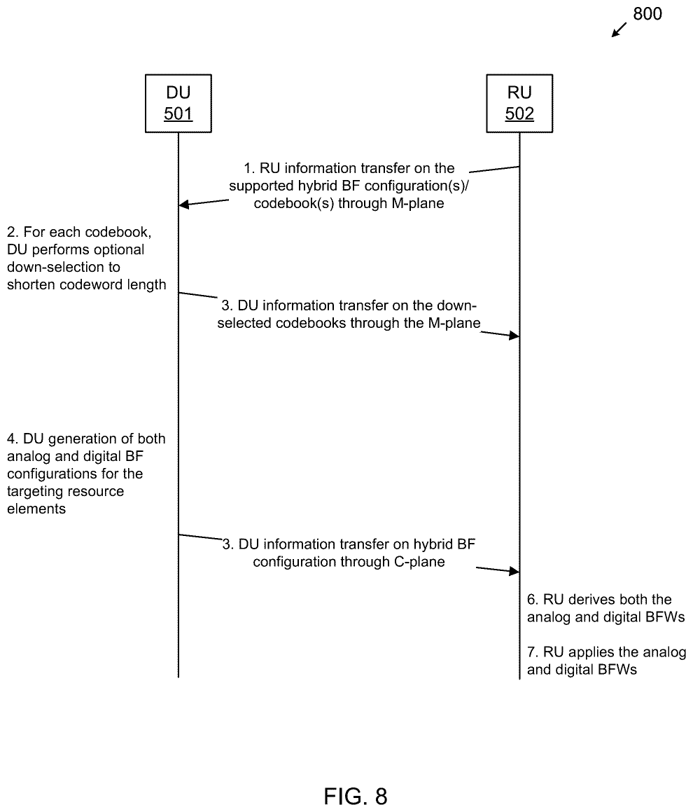

FIG. 8 is a signaling diagram illustrating an example of hybrid beamforming for use in connection with the O-RAN fronthaul according to embodiments of the present disclosure. The embodiment of the signaling 800 shown in FIG. 8 is for illustration only. FIG. 8 does not limit the scope of this disclosure to any particular implementation of signaling.

In the example shown in FIG. 8, which illustrates DU and RU operations, the steps in the figure explain UL spatial combining weights configuration and MIMO data reception as below:
1. RU information transfer on the supported hybrid BF configuration(s)/codebooks through the M-plane: The RU transports information of the supported hybrid beamforming configuration information to the DU using the M-plane. The configuration information includes the number of analog ports, the digital ports (transceivers), the number of analog ports per transceiver, and the codebooks (for example, digital BF weights, analog phase-shifter control bit vectors, analog beam ID, analog beam group ID, etc.).
2. For each codebook, the DU performs optional down-selection to shorten the codeword length: The DU optionally down-selects from the codebooks provided by the RU in the previous step.
3. DU information transfer on the down-selected codebooks through the M-plane: The DU optionally transports information on the down-selected codebooks to the RU through the M-plane. The RU updates the codebooks accordingly.
4. DU generation of both t analog and digital beamforming configuration for the targeting resource elements: The DU generates the analog/digital beamforming weights or selects analog/digital beam IDs to indicate the beamforming weights.
5. DU information transfer on the hybrid beamforming configuration through the C-plane: The DU configures hybrid beamforming to the RU through a C-plane message. Both digital and analog beamforming configurations will be indicated. The format of the beam IDs and the value of beamforming weights (BFWs) are according to the hybrid beamforming configuration.
6. The RU derives both the analog and digital beamforming weights: The RU decodes the analog/digital beamforming weights from the C-plane message directly or using beam IDs with codebooks. The hybrid beamforming configurations per target resource element are resolved.
7. The RU applies the analog and digital beamforming weights: The RU applies the hybrid beamforming.

In some embodiments of the second step in FIG. 8, the DU transfers the codebook required with the candidate spatial combining methods:
DU requirement of down selection from the codebook: The DU sends a requirement of down selecting certain or multiple codebooks in step 2 for a shortened bit width.
Down selection per application scenario: The down selection of the codebooks is assigned with certain applications. For example, in the DL, the codebook of phase shifter values does not involve down selection; in the UL, the same codebook is down-selected with every other phase-shifter value.

In some embodiments, the RU has multiple groups of the settings or options. The RU informs the DU of the supported groups of the hybrid beamforming settings through the M-plane. The DU configures a group number to the RU and the RU will apply the corresponding hybrid beamforming setting.

M-plane signaling design: At the initial handshake phase between the RU and the DU, the RU first transfers the beamforming configuration information to the DU in the step 1 shown in FIG. 8 through the M-plane. The detailed signaling for step 1 and step 3 are explained as below.

In the M-plane signaling: The DU send a request for the beamforming configuration report from the RU as part [1]. The RU replies to the request by sending the beamforming configuration through predefined format as part [2]. The codebook for digital and analog beamforming is included. The DU receives and optionally down-select from the codebooks and sends the down-selected codebook back to the RU in part [3]. The RU transmits acknowledgement, in part [4], of whether/which down-selection is accepted and will be applied.

In an embodiment, the following is added to the Yet Another Next Generation (YANG) data modeling language model for the M-plane hybrid beamforming configuration:

```
grouping hybrid-bf-configuration {
  leaf hybrid-bf-analog-phase-shifter-parameter {
    type enumeration {
      enum CTRL_BITS {
        description
        “The analog phase-shifter is configured by control bit-vector.
        The codebook of bit-vector to phase mapping is configured
        through M-plane.”;
      }
      enum IQ_VALUES {
        description “The analog phase-shifter is configured by through a
        pair of I/Q values.”;
      }
    }
  }
  leaf phase-shifter-bitwidth {
    type uint4;
    mandatory true;
    description “the bit-width of the phase-shifter's control bit-vector or
    I/Q values.”;
  }
  leaf analog-beam-id-bitwidth {
    type uint4;
    mandatory true;
    description “the bit-width of the analog beam ID.”;
  }
    leaf analog-beam-group-bitwidth {
    type uint4;
      default 15;
    mandatory true;
    description “the bit-width of the analog beam ID.”;
  }
  leaf is-digital-analog-beam-id-coupled {
    type boolean;
    mandatory true;
    description “If true, the beam ID of the hybrid BF is associated with
    both digital and analog BF weights.
      If false, the digital and analog BF have separate beam ID
      codebooks.”;
  }
  container phase-shifter-codebook {
    when “../hybrid-bf-analog-phase-shifter-parameter = CTRL_BITS”;
    list control-bit-vector {
      key control-bit-vector;
      leaf phase-value {
        type dicimal64 {
          fraction-digits 2;
        }
        description “The phase value in degree.”;
      }
      description “The mapping from the control bit-vector to the actual
      phase value.”; }
  }
  container analog-beam-id-codebook {
    list analog-beam-id {
        key beam-id;
      leaf bit-vector-config {
        type uint16;
      }
      description “The beam ID of TRX control. The effective beam ID
      is on the LSBs. The bit-width is indicated by
      ../analog-beam-id-bitwidth.”;
    }
  }
  container analog-beam-group-id {
    list analog-beam-group-id {
      key beam-group-id;
        leaf beam-id-config {
        type uint16;
      }
      description “The analog beam group ID of analog BF
      configuration.”;
    }
  }
}
```

In this example YANG model, the RU reports the hybrid beamforming configuration to the DU through “hybrid-bf-configuration”. Two types of analog phase-shifter configuration options can be supported by the RU:
CTRL_BITS: The RU uses control bit vectors for phase shifter value configuration. The codebook of the bit vector to the value is transferred in the M-plane (../phase-shifter-control).
IQ_VALUES: This option aims to support the existing O-RAN specification way of phase-shifter configuration, i.e., transfer of I/Q values.

The bit width of the phase shifter control bit vector is configured in the “phase-shifter-bitwidth”. The bit width of the analog beam ID is in the “analog-beam-id-bitwidth”. Both of the bit-widths are reported by the RU to the DU in the M-plane. Such bit widths are used in the C-plane messages.

The bit width of the analog beam group ID is configured in the “analog-beam-group-bitwidth”. The default value is 15 and optionally has an RU specific value.

The RU optionally has one overall beam ID associated to both digital and analog beamforming weights, using “is-digital-analog-beam-id-coupled=true”. The RU may also decouple the digital and analog beamforming weights, with the beam ID specifically associated with digital beamforming weights.

The analog beam group ID and beam ID are associated to the analog beamforming weights, using “is-digital-analog-beam-id-coupled=false”.

The analog beamforming related codebooks are configured by the following containers in the above YANG model: “phase-shifter-codebook”, “analog-beam-id-codebook”, “analog-beam-group-id”, etc.

An example of the “phase-shifter-codebook” mapping is shown in TABLE 1:

TABLE 1
Example of control bit vector to phase shifter value mapping

| control-bit-vector | phase-value | I | Q |
|---|---|---|---|
| 0000b | 0 deg | 1.0000 | 0.0000 |
| 0001b | 30 deg | 0.8660 | 0.5000 |
| 0010b | 60 deg | 0.5000 | 0.8660 |
| 0011b | 90 deg | 0.0000 | 1.0000 |
| 0100b | 120 deg | −0.5000 | 0.8660 |
| 0101b | 150 deg | −0.8660 | 0.5000 |
| 0110b | 180 deg | −1.0000 | 0.0000 |
| 0111b | 210 deg | −0.8660 | −0.5000 |
| 1000b | 240 deg | −0.5000 | −0.8660 |
| 1001b | 270 deg | −0.0000 | −1.0000 |
| 1010b | 300 deg | 0.5000 | −0.8660 |
| 1011b | 330 deg | 0.8660 | −0.5000 |

In some embodiments, the RU transfers multiple groups of “hybrid-bf-configuration” to the DU. Each group of “hybrid-bf-configuration” refers to a group of different settings. The DU selects one group of the “hybrid-bf-configuration” for hybrid beamforming configuration and transfers the group number to the RU through the M-plane.

C-plane signaling design: In step 5 illustrated in FIG. 8, the DU transfers the configuration of hybrid beamforming to the RU through C-plane messages.
The analog phase shifters are configured by control bit vectors.
The bit width of the analog beam ID follows the M-plane configuration in step 1 to 3 in FIG. 8.
Each of the analog beam group ID, analog beam ID, analog control bit vector, digital beam ID, and digital beamforming weights are designed with a control bit to indicate if the information is disabled.

Section extension for hybrid BF configuration: An example of the hybrid beamforming C-plane configuration is shown in TABLE 2 below as a section extension:

TABLE 2
Section Extension X: hybrid beamforming weights configuration

| | | | | | | | | # of |
|---|---|---|---|---|---|---|---|---|
| 0 (msb) | 1 | 2 | 3 | 4 | 5 | 6 | 7 (Isb) | bytes |

| ef | extType = 0x0X | | | | | 1 | Octet N |
|---|---|---|---|---|---|---|---|
| extLen[15:0] | | | | | | 2 | Octet N + 1 |
| disableDigBfws | RAD | disableDigBeamId | disableAnaBfws | disableAnaBeamId | reserved | | Octet N + 3 |

(3 bits)

| numBundPrb[7:0] | | var | Octet N + 4 |
|---|---|---|---|
| reserved | analogBeamGroupId[14:8] | 1 | |
| analogBeamGroupId[7:0] | | 1 | |
| digBfwCompHdr[7:0] (for digital BF) | | var | |
| analogBeamId (for TRX 0) | | var | |
| tdBfParamPhase (for analog port 0 for TRX 0) | | var | |
| remaining beamforming weights bfwTheta up to K/K′ analog port for TRX 0 | | var | |
| . . . | | | |
| analogBeamId (for TRX K′) | | var | |
| tdBfParamPhase (for analog port 0 for TRX K′) | | var | |
| remaining beamforming weights bfwTheta up to K/K′ analog port for TRX K′ | | var | |
| digBfwCompParam (for PRB bundle 0) | | var | |
| contInd | beamId[14:8] (for PRB bundle 0) | 1 | |
| beamId[7:0] (for PRB bundle 0) | | 1 | |
| bfwI (for digital port 0 and PRB bundle 0) | | var | |
| bfwQ (for digital port 0 and PRB bundle 0) | | var | |
| remaining beamforming weights bfwI and bfwQ up to K′ digital port and PRB bundle 0 | | var | |
| digBfwCompParam (for PRB bundle 1) | | var | |
| contInd | beamId[14:8] (for PRB bundle 1) | 1 | |
| beamId[7:0] (for PRB bundle 1) | | 1 | |
| bfwI (for digital port 0 and PRB bundle 1) | | var | |
| bfwQ (for digital port 0 and PRB bundle 1) | | var | |
| remaining beamforming weights bfwI and bfwQ up to K′ digital ports and PRB bundle 1 | | var | |
| . . . | | | |
| digBfwCompParam (for last PRB bundle) | | var | |
| contInd | beamId[14:8] (for last PRB bundle) | 1 | |

| | |
|---|---|
| beamId[7:0] (for last PRB bundle) | 1 |
| bfwI (for digital port 0 and last PRB bundle) | var |
| bfwQ (for digital port 0 and last PRB bundle) | var |
| remaining beamforming weights bfwI and bfwQ up to K′ digital ports and last PRB bundle | var |
| zero pad to 4-byte boundary | var |

Within the SE-X header (the first six lines in TABLE 2), the fields “disableAnaBfws” (an on/off control for analog beamforming weights), “analogBeamGroupId[14:8]”, and “analogBeamGroupId[7:0]” existed in ST4, but were not in the existing SE header. The SE-X header introduces on/off controls for digital beam ID (“disableDigBeamId”) and analog beam ID (“disableAnaBleamld”). The control disableAnaBeamId dedicatedly controls the existence of an analog beam ID, but not analog beamforming weights (which differs from ST4). Within the analog beamforming weights configuration section of TABLE 2 (the seven lines following the header), “analogBeamId” for transceiver 0 through transceiver K′ existed in ST4. The variable “tdflfParamPhase”, which is control bit vector for each phase shifter, is new. The remainder of TABLE 2 includes digital beamforming weights configuration per subband (PRB bundle), which existed in SE11 in the O-RAN specification.

In an embodiment, the DU utilizes a new section extension X (SE-X) to configure both digital and analog beamforming weights. The SE-X format is illustrated in TABLE 2, which includes: 1) section extension headers, 2) weights/beam IDs of digital/analog beamforming indicators, 3) hybrid beamforming specific configuration, 4) analog beamforming weights configuration, 5) per subband digital beamforming weights configuration.

An explanation of the entries in the SE-X format of TABLE 2 is provided below:

### 1) Section Extension Headers:

The header uses O-RAN specification default format and includes:
i. “ef” as extension flag to indicate if another section extension is attached to the current SE-X;
ii. “extType=0x0X” as the index of the section type, here shall be X.
iii. “extLen” as the total length in words of SE-X. To adapt scenarios requires heavy digital BF weights configuration, the “extLen” occupies two bytes.

### 2) Weights/Beam ID of Digital/Analog BF Indicators:

The existence of the beamforming weights or beam IDs of the analog or digital beamforming are indicated by 4 bits. In this way, the DU owns flexibility to apply SE-X in scenarios without redundancy of unnecessary information.
i. “disableDigBfws” as a flag to indicate if digital beamforming weights are disabled. Value 0 means the digital BF weights are included in SE-X; value 1 means the digital beamforming weights are not included in SE-X. This bit exists in the O-RAN specification.
ii. “disableDigBeamId” as a new added flag to indicate if digital beam IDs are disabled. Value 0 means the digital beam IDs are included in SE-X; value 1 means the digital beam IDs are not included in SE-X.
iii. “disableAnaBfws” as a new added flag to indicate if analog beamforming weights are disabled. Value 0 means the analog beamforming weights are included in SE-X; value 1 means the analog beamforming weights are not included in SE-X.
iv. “disableAnaBeamId” as a new added flag to indicate if analog beam IDs are disabled. Value 0 means the analog beam IDs are included in SE-X; value 1 means the analog beam IDs are not included in SE-X.
v. “RAD” as an indicator of reset after PRB discontinuity, as existed in SE11 in the O-RAN specification.

In some embodiments, the value of the indicators also affects the existence of the other variable in SE-X. For example, if the digital beamforming weights are absent, the compression command is also absent for reducing the C-plane message traffic. The variation of the SE-X due to the digital/analog beamforming weights/beam ID indicators are summarized in TABLE 3 and TABLE 4 below, for digital and analog beamforming respectively:

TABLE 3
SE-X variation with digital beamforming weights/beamId disabled

| disable | DisableDig | Descriptions |
|---|---|---|
| DigBfws | BeamId | (for digital BF beamId/BFW) |
| 1 | 1 | Nether beamId and BFWs are included. |
| | | The digital beam is associated with beamId |
| | | in ST1. Same digital BFW will apply for |
| | | all PRBs. |
| | | “numBundPrb”, “digBfwCompHdr”, |
| | | and “contInd” shall absent. |
| 1 | 0 | Only “beamId” is included. |
| | | “digBfwCompHdr” and |
| | | “digBfwCompParam” shall absent. |
| 0 | 1 | “beamId” is absent. The |
| | | first “bfwl” will follow |
| | | the “contInd” in each PRB bundle. |
| 0 | 0 | All “beamId”, “BFWs”, “numBundPrb”, |
| | | “digBfwCompHdr”, and |
| | | “contInd” are included. |

TABLE 4
SE-X variation with analog beamforming weights/beamId disabled

| disable | disableAna | Descriptions |
|---|---|---|
| AnaBfws | BeamId | (for analog BF beamId/BFW) |
| 1 | 1 | Only 15 bits analog beam group ID is included. |
| | | “anaBfwCompHdr” and |
| | | “anaBfwCompParam” shall |
| | | absent, if they exist. |
| 1 | 0 | For each TRX, only a beamId is included. |
| | | “anaBfwCompHdr” and “anaBfwCompParam” |
| | | shall absent, if they exist. |
| 0 | 1 | For each TRX, only K/K′ |
| | | analog BFWs are included. |
| 0 | 0 | For each TRX, one beamId and |
| | | K/K′ analog BFWs are included. |

### 3) Hybrid BF Specific Configuration:

i. “numBundPrb” indicates the number of the PRB bundle or the number of the subbands for the digital beamforming configuration. This feature exists in the SE11 in the O-RAN specification.
ii. “analogBeamGroupId” occupies 15 bits and is mapped to K values for all phase shifters. The mapping of the “analogBeamGroupId” to the analog beam ID of each transceiver is optional. If the analog beam ID and/or analog beamforming weights are included in the SE-X, the RU associates the “analogBeamGroupId” to analog beam ID and/or analog beamforming weights for the usage in the futured arriving of the C-plane messages.
iii. “digBfwCompHdr” is the digital beamforming weight compression header, following the same definition in the O-RAN specification, which is absent if the “disableDigBfws=1”.

### 4) Analog BFW Configuration:

If at least one of “disableAnaBfws” and “disableAnaBeamId” has value 0, in total K′ groups analog beamforming weights configuration information will be transferred. In each group:
i. “analogBeamId” contains the analog beam ID for the certain transceivers. The bit width of the “analogBeamId” is configured in the M-plane in steps 1 through 3 in FIG. 8. If “disableAnaBeamId=1”, the “analogBeamId” will be absent; otherwise, only one “analogBeamId” exists per transceiver.
ii. “tdBfParamPhase” contains the phase configuration for the phase shifters in the certain transceivers. The bit width of the “tdBfParamPhase” is configured in the M-plane in steps 1 through 3 in FIG. 8. If “disableAnaBfws=1”, the “tdBfParamPhase” will be absent; otherwise, K/K′ “tdBfParamPhase” exists per transceiver.

### 5) Per Subband Digital BF Weights Configuration

The digital beamforming has option of per subband granularity. The subband width relate to the PRB range configured in the section type header and “numBundPrb” in the SE-X. For each subband:
i. “digBfwCompParam” contains a parameter for digital beamforming weight compression, following the same definition in the O-RAN specification, but is absent if the “disableDigBfws=1”.
ii. “beamId” is a 15 bit digital beam ID associated to certain digital beamforming weights. If the digital beamforming weights exist in the SE-X, the RU associates the digital beamforming weights to this “beamId” for usage with C-plane messages arriving in the future. If “disableDigBeamId=1”, the “beamId” will be absent; otherwise, one “beamId” exists per subband.
iii. “bfwI” and “bfwQ” are the digital beamforming weights. In total, K′ pairs of “bfwI” and “bfwQ” exist when “disableDigBfws=0”, otherwise, the digital beamforming weights are absent. Both “bfwI” and “bfwQ” are controlled by “digBfwCompHdr” in the header of SE-X, and “digBfwCompParam” is given per subband.
iv. “contInd” is the PRB region continuity flag, as exists in SE11 in the O-RAN specification.

### Additional Variations to SE-X.

In some embodiments, some/all of the bits in SE-X for disabling the analog/digital beamforming weights/beam ID are not present. The analog/digital beamforming weights/beam ID are always existing or always absent.
In some embodiments, the three reserved bits in the next row of the “extLen” are used to indicate the number of the analog beamforming weights per analog port, e.g., “numAnaBfVal=N” or “numAddiAnaBfVAl=N−1”, where N is the number of values needed in the analog beamforming weights. By default, in SE-X, only 1 value is need for analog beamforming weights, which is the control bit vector for the phase shifter (configured in the M-plane). However, to adapt to other configurations (for example, in which the I/Q value per phase shifter is preferred), “numAnaBfVal” is 2 or “numAddiAnaBfVAl” is 1. In some scenarios, where the I/Q value of phase shifters and a configuration of power-amplifier (3 values) are needed, then “numAnaBfVal” is 3 or “numAddiAnaBfVAl” is 2. The meaning and sequence of the analog beamforming values are defined through the M-plane. In SE-X, “tdBfParamPhase” is replaced by “tdBfParam1”, “tdBfParam2”, . . . , “tdBfParamN” for each analog port in the transceiver.
In some embodiments, zero padding exists after a) analog beamforming configuration of each transceiver, b) the entire analog beamforming configuration, c) each subband of digital beamforming configuration.

### Examples of Hybrid BF Configuration Using SE-X—Control Bit-Vector Versus I/Q for Phase-Shifters.

In one example, the RU has K=1024 analog ports, K′=64 digital ports. In a scenario, the DU shall configure the analog beamforming weights through C-plane to the RU.
1) In the case that “hybrid-bf-analog-phase-shifter-parameter” in the YANG model above is configured as “CTRL_BITS”:
Assume the control bit vector has 4 bits as illustrated in TABLE 1. An example of the analog beamforming weights configuration in SE-X is shown below in TABLE 5 below (4×1024=4096 bits are used in total for analog BF weights configuration):

TABLE 5
Example of SE-X in “CTRL_BITS” mode

| | | | | | | | | |
|---|---|---|---|---|---|---|---|---|
| 0 (msb) | 1 | 2 | 3 | 4 | 5 | 6 | 7 (Isb) | # of bytes |

| ef | extType = 0x0X | | | | | 1 |
|---|---|---|---|---|---|---|
| extLen[15:0] | | | | | | 2 |
| disableDigBfws = 1 | RAD | disableDigBeamId = 1 | disableAnaBfws = 0 | disableAnaBeamId = 1 | reserved | 1 |

(3 bits)

| | | |
|---|---|---|
| reserved | analogBeamGroupId[14:8] | 1 |

| analogBeamGroupId[7:0] | | 1 |
|---|---|---|
| 0010b (for 1^{st} analog port) | 0011b (for 2^{nd} analog port) | 1 |
| 0000b (for 3^{rd} analog port) | 0111b (for 4^{th} analog port) | 1 |
| . . . | | |
| 1011b (for 15^{th} analog port) | 0011b (for 16^{th} analog port) | 1 |
| . . . | | |
| 0101b (for 1009^{th} analog port) | 0110b (for 1010^{th} analog port) | 1 |
| 0010b (for 1011^{th} analog port) | 0001b (for 1012^{th} analog port) | 1 |
| . . . | | |
| 1010b (for 1023^{rd} analog port) | 0011b (for 1024^{th} analog port) | 1 |

| | |
|---|---|
| zero pad to 4-byte boundary | var |

2) In the case that “hybrid-bf-analog-phase-shifter-parameter” in the YANG model above is configured as “IQ_VALUES”:
Assume the control bit-vector to I/Q mapping as illustrated in Table 1, and I/Q values are in 8 bit format (block floating point, for example). An example of the analog beamforming weights configuration in SE-X is shown in TABLE 6 below (8×2×1024=16,384 bits are used in total for analog beamforming weights configuration):

TABLE 6
Example of SE-X in “IQ_VALUES” mode

| | | | | | | | | |
|---|---|---|---|---|---|---|---|---|
| 0 (msb) | 1 | 2 | 3 | 4 | 5 | 6 | 7 (Isb) | # of bytes |

| ef | extType = 0x0X | | | | | 1 |
|---|---|---|---|---|---|---|
| extLen[15:0] | | | | | | 2 |
| disableDigBfws = 1 | RAD | disableDigBeamId = 1 | disableAnaBfws = 0 | disableAnaBeamId = 1 | reserved | 1 |

| | | (3 bits) | |
|---|---|---|---|
| reserved | analogBeamGroupId[14:8] | | 1 |

| | |
|---|---|
| analogBeamGroupId[7:0] | 1 |
| I = 0.500 (for 1^{st} analog port) | 1 |
| Q = 0.8660 (for 1^{st} analog port) | 1 |
| I = 0.0000 (for 2^{nd} analog port) | 1 |
| Q = 1.0000 (for 2^{nd} analog port) | 1 |
| . . . | |
| I = 0.0000 (for 16^{th} analog port) | 1 |
| Q = 1.0000 (for 16^{th} analog port) | 1 |
| . . . | |
| I = −0.8660 (for 1009^{th} analog port) | 1 |
| Q = 0.500 (for 1009^{th} analog port) | 1 |
| I = −1.0000 (for 1010^{th} analog port) | 1 |
| Q = 0.0000 (for 1010^{th} analog port) | 1 |
| . . . | |
| I = 0.0000 (for 1024^{th} analog port) | 1 |
| Q = 1.0000 (for 1024^{th} analog port) | 1 |
| zero pad to 4-byte boundary | var |

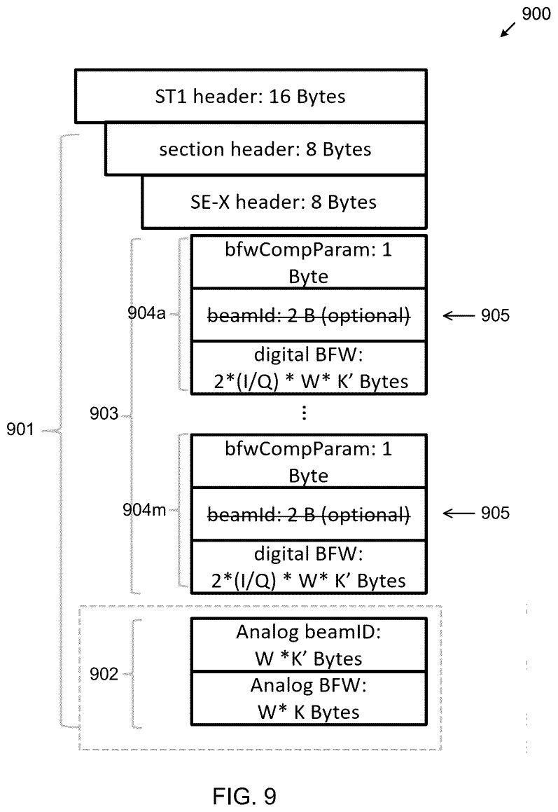

FIG. 9 illustrates an example of hybrid weight-based dynamic beamforming configuration that may be used in connection with hybrid beamforming for O-RAN fronthaul according to embodiments of the present disclosure. The embodiment of hybrid weight-based dynamic beamforming configuration 900 shown in FIG. 9 is for illustration only. FIG. 9 does not limit the scope of this disclosure to any particular hybrid weight-based dynamic beamforming configuration.

In one example, the RU has K analog ports, K′ transceivers, and L layers of data. The common header of ST1 requires 16 bytes. The C-plane message is composed by ST1 (including the SE-X header proposed herein) with per-layer values 901 (for each data layer), as illustrated in FIG. 9. For each layer, the section header uses 8 bytes and the SE-X header uses 8 bytes.

Both analog and digital beamforming weights need to be transferred from the DU to the RU. Accordingly, the embodiment of hybrid weight-based dynamic beamforming configuration 900 in FIG. 9 includes analog values 902 of values for each layer. For the analog beamforming, both analog beam ID and phase shifter values are required for each transceiver. Accordingly, the per-layer values 901 includes analog beamforming values 902 for analog beamforming weights, which can be an analog beam ID and corresponding analog beamforming weights, that are only needed for the first layer. The configured analog beam group ID can be the same for all layers.

For the analog beamforming values 902, in the first layer, the analog beam ID and analog beamforming weights are transmitted. In total, W*(K+K′) bytes are transferred. For the rest of the layers, the analog beam ID and analog beamforming weights are disabled. The RU will use the analog beam group ID in the header of SE-X, which has been associated with the same analog beam ID and beamforming weights in the first layer.

For digital beamforming, the digital beamforming weights 903 are configured and transferred per subband, so the per-layer values 901 include M digital value sets 904a through 904m, one for each of the M subbands. Each beamforming weight and each beam ID requires W bytes. For each subband, 1 byte is used for the compression header, and the weights consume 2*W*K′ bytes.

In total, the length of the C-plane message to achieve the hybrid BF configuration in this example is: 16+L*(8+8+M*(1+2+W*K′))+(W*K′+K) bytes. The digital “beamId” 905 for each layer may be configured as disabled or not transmitted, which (assuming 273 subbands and 64 layers) saves: 2 bytes×273 SBs×64 layers=34944 bytes.

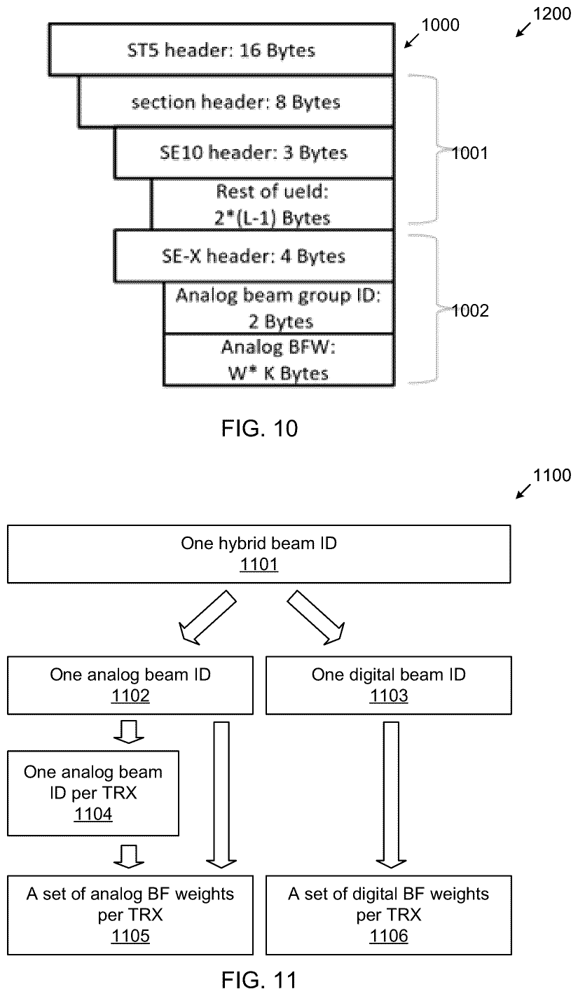

FIG. 10 illustrates an example of hybrid CSI-based beamforming configuration that may be used in connection with hybrid beamforming for O-RAN fronthaul according to embodiments of the present disclosure. The embodiment of hybrid CSI-based beamforming configuration 1000 shown in FIG. 10 is for illustration only. FIG. 10 does not limit the scope of this disclosure to any particular hybrid CSI-based beamforming configuration.

In the example hybrid CSI-based beamforming configuration 1000, the RU has K analog ports, K′ transceivers, and L layers of data. The DU configures the RU use CSI-based BF for the digital BF (associated with the ueld), so UE IDs are required. The UE ID information 1001 is transferred using ST5 with SE10. The common header of ST5 requires 16 bytes. The section description requires 8 bytes, including the UE ID of the representative layer. The SE10 requires 3 bytes for header and 2 bytes for each remaining layer.

For the analog BF, the analog phase-shifter values are required per transceiver. For simplicity, each BF weight and each beam ID requires W bytes. The C-plane message is composed by ST5 with SE10 and SE-X for each data layer, as illustrated in FIG. 10. SE-X has a 4 byte header and, for the analog beamforming, is accompanies by the analog beam ID and analog BF weights, transmitted as the analog beamforming configurations 1002. In total, W*(K+K′) bytes. In total, the length of the C-plane message to achieve the hybrid BF configuration in this example is: 16+8+3+2*(L−1)+4+2+W*K bytes.

In some embodiments, the analog phase-shifter values are sent directly to the RU and are compressed similar to the digital BF weights. Both “anaBfwCompHdr” and “anaBfwCompParam” are added to the header of SE-X₁, as illustrated in TABLE 7:

TABLE 7
Section Extension X₁: hybrid beamforming weights configuration with analog beamforming
compression configuration: per transceiver compression parameter

| | | | | | | | | # of |
|---|---|---|---|---|---|---|---|---|
| 0 (msb) | 1 | 2 | 3 | 4 | 5 | 6 | 7 (Isb) | bytes |

| ef | extType = 0x0X₁ | | | | | 1 | Octet N |
|---|---|---|---|---|---|---|---|
| extLen[15:0] | | | | | | 2 | Octet N + 1 |
| disableDigBfws | RAD | disableDigBeamId | disableAnaBfws | disableAnaBeamId | reserved | 1 | Octet N + 3 |

(3 bits)

| numBundPrb[7:0] | | var | Octet N + 4 |
|---|---|---|---|
| reserved | analogBeamGroupId[14:8] | 1 | |
| analogBeamGroupId[7:0] | | 1 | |
| anaBfwCompHdr[7:0] (for analog BF) | | var | |
| digBfwCompHdr[7:0] (for digital BF) | | var | |
| anaBfwCompParam (for TRX 0) | | var | |
| analogBeamId (for TRX 0) | | var | |
| tdBfParamPhase (for analog port 0 for TRX 0) | | var | |
| remaining beamforming weights bfwTheta up to K/K′ analog port for TRX 0 | | var | |
| . . . | | | |
| anaBfwCompParam (for TRX K′) | | var | |
| analogBeamId (for TRX K′) | | var | |
| tdBfParamPhase (for analog port 0 for TRX K′) | | var | |
| remaining beamforming weights bfwTheta up to K/K′ analog port for TRX K′ | | var | |
| digBfwCompParam (for PRB bundle 0) | | var | |
| contInd | beamId[14:8] (for PRB bundle 0) | 1 | |
| beamId[7:0] (for PRB bundle 0) | | 1 | |
| bfwI (for digital port 0 and PRB bundle 0) | | var | |
| bfwQ (for digital port 0 and PRB bundle 0) | | var | |
| remaining beamforming weights bfwI and bfwQ up to K′ digital port and PRB bundle 0 | | var | |
| digBfwCompParam (for PRB bundle 1) | | var | |
| contInd | beamId[14:8] (for PRB bundle 1) | 1 | |
| beamId[7:0] (for PRB bundle 1) | | 1 | |
| bfwI (for digital port 0 and PRB bundle 1) | | var | |
| bfwQ (for digital port 0 and PRB bundle 1) | | var | |
| remaining beamforming weights bfwI and bfwQ up to K′ digital port and PRB bundle 1 | | var | |
| . . . | | | |
| digBfwCompParam (for last PRB bundle) | | var | |
| contInd | beamId[14:8] (for last PRB bundle) | 1 | |

| | |
|---|---|
| beamId[7:0] (for last PRB bundle) | 1 |
| bfwI (for digital port 0 and last PRB bundle) | var |
| bfwQ (for digital port 0 and last PRB bundle) | var |
| remaining beamforming weights bfwI and bfwQ up to K′ digital ports and last PRB bundle | var |
| zero pad to 4-byte boundary | var |

The “anaBfwCompParam” also exists per transceiver, instead of in the header, as illustrated in TABLE 8:

TABLE 8
Section Extension X₂: hybrid beamforming weights configuration with analog beamforming
compression configuration: shared compression parameter over transceivers

| | | | | | | | | # of |
|---|---|---|---|---|---|---|---|---|
| 0 (msb) | 1 | 2 | 3 | 4 | 5 | 6 | 7 (Isb) | bytes |

| ef | extType = 0x0X₂ | | | | | 1 | Octet N |
|---|---|---|---|---|---|---|---|
| extLen[15:0] | | | | | | 2 | Octet N + 1 |
| disableDigBfws | RAD | disableDigBeamId | disableAnaBfws | disableAnaBeamId | reserved | 1 | Octet N + 3 |

(3 bits)

| numBundPrb[7:0] | | var | Octet N + 4 |
|---|---|---|---|
| reserved | analogBeamGroupId[14:8] | 1 | |
| analogBeamGroupId[7:0] | | 1 | |
| anaBfwCompHdr[7:0] (for analog BF) | | var | |
| digBfwCompHdr[7:0] (for digital BF) | | var | |
| anaBfwCompParam (for TRX 0) | | var | |
| analogBeamId (for TRX K′) | | var | |
| tdBfParamPhase (for analog port 0 for TRX 0) | | var | |
| remaining beamforming weights bfwTheta up to K/K′ analog port for TRX 0 | | var | |
| . . . | | | |
| analogBeamId (for TRX K′) | | var | |
| tdBfParamPhase (for analog port 0 for TRX K′) | | var | |
| remaining beamforming weights bfwTheta up to K/K′ analog port for TRX K′ | | var | |
| digBfwCompParam (for PRB bundle 0) | | var | |
| contInd | beamId[14:8] (for PRB bundle 0) | 1 | |
| beamId[7:0] (for PRB bundle 0) | | 1 | |
| bfwI (for digital port 0 and PRB bundle 0) | | var | |
| bfwQ (for digital port 0 and PRB bundle 0) | | var | |
| remaining beamforming weights bfwI and bfwQ up to K′ digital port and PRB bundle 0 | | var | |
| digBfwCompParam (for PRB bundle 1) | | var | |
| contInd | beamId[14:8] (for PRB bundle 1) | 1 | |
| beamId[7:0] (for PRB bundle 1) | | 1 | |
| bfwI (for digital port 0 and PRB bundle 1) | | var | |
| bfwQ (for digital port 0 and PRB bundle 1) | | var | |
| remaining beamforming weights bfwI and bfwQ up to K′ digital port and PRB bundle 1 | | var | |
| . . . | | | |
| digBfwCompParam (for last PRB bundle) | | var | |
| contInd | beamId[14:8] (for last PRB bundle) | 1 | |

| | |
|---|---|
| beamId[7:0] (for last PRB bundle) | 1 |
| bfwI (for digital port 0 and last PRB bundle) | var |
| bfwQ (for digital port 0 and last PRB bundle) | var |
| remaining beamforming weights bfwI and bfwQ up to K′ digital ports and last PRB bundle | var |
| zero pad to 4-byte boundary | var |

Section type of hybrid BF configuration: The hybrid beamforming C-plane configuration is transmitted in section type in some embodiment.

An embodiment is shown in TABLE 9:

TABLE 9
Section Type X: hybrid beamforming weights configuration

| | | | | | | | | # of |
|---|---|---|---|---|---|---|---|---|
| 0 (msb) | 1 | 2 | 3 | 4 | 5 | 6 | 7 (Isb) | bytes |

| transport header: see clause 5.1.3 | | | 8 | Octet 1 |
|---|---|---|---|---|
| dataDirection | payloadVersion | filterIndex | 1 | Octet 9 |

| frameID | | 1 | Octet 10 |
|---|---|---|---|
| subframeID | slotId | 1 | Octet 11 |

| | | | |
|---|---|---|---|
| slotId | startSymbolID | 1 | Octet 12 |

| numberOfSections | | | | 1 | Octet 13 |
|---|---|---|---|---|---|
| sectionType = X | | | | 1 | Octet 14 |
| udCompHdr | | | | 1 | Octet 15 |
| reserved | | | | 1 | Octet 16 |
| sectionId | | | | 1 | Octet 17 |
| sectionId | rb | symInc | startPrbc | 1 | Octet 18 |

| startPrbc | | | | | | 1 | Octet 19 |
|---|---|---|---|---|---|---|---|
| numPrbc | | | | | | 1 | Octet 20 |
| reMask[11:4] | | | | | | 1 | Octet 21 |
| reMask[3:0] | | | numSymbol | | | 1 | Octet 22 |
| ef | analogBeamGroupId[14:8] | | | | | 1 | Octet 23 |
| analogBeamGroupId[7:0] | | | | | | 1 | Octet 24 |
| disableDigBfws | RAD | disableDigBeamId | disableAnaBfws | disableAnaBeamId | reserved | var | |

(3 bits)

| digBfwCompHdr[7:0] (for digital BF) | | var |
|---|---|---|
| analogBeamId (for TRX K′) | | var |
| tdBfParamPhase (for analog port 0 for TRX 0) | | var |
| remaining beamforming weights bfwTheta up to K/K′ analog port for TRX 0 | | var |
| . . . | | |
| analogBeamId (for TRX K′) | | var |
| tdBfParamPhase (for analog port 0 for TRX K′) | | var |
| remaining beamforming weights bfwTheta up to K/K′ analog port for TRX K′ | | var |
| digBfwCompParam (for PRB bundle 0) | | var |
| contInd | beamId[14:8] (for PRB bundle 0) | var |
| beamId[7:0] (for PRB bundle 0) | | var |
| bfwI (for digital port 0 and PRB bundle 0) | | var |
| bfwQ (for digital port 0 and PRB bundle 0) | | var |
| remaining beamforming weights bfwI and bfwQ up to K′ digital port and PRB bundle 0 | | var |
| digBfwCompParam (for PRB bundle 0) | | var |
| contInd | beamId[14:8] (for PRB bundle 0) | var |
| beamId[7:0] (for PRB bundle 0) | | var |
| bfwI (for digital port 0 and PRB bundle 0) | | var |
| bfwQ (for digital port 0 and PRB bundle 0) | | var |
| remaining beamforming weights bfwI and bfwQ up to K′ digital port and PRB bundle 0 | | var |
| . . . | | |
| digBfwCompParam (for last PRB bundle) | | var |
| contInd | beamId[14:8] (for last PRB bundle) | var |

| | |
|---|---|
| beamId[7:0] (for last PRB bundle) | var |
| bfwI (for digital port 0 and last PRB bundle) | var |
| bfwQ (for digital port 0 and last PRB bundle) | var |
| remaining beamforming weights bfwI and bfwQ up to K′ digital ports and last PRB bundle | var |
| Section Extensions as indicated by ‘ef’ | var |

The fields of the ST-X for hybrid beamforming configuration are the same as the SE-X illustrated in TABLE 2. The variations of SE-X are applicable for ST-X.

In a second embodiment, the beamId in section type 1 is designed as a hybrid beam ID in hybrid BF RU, and:
The beam ID in ST1 is re-interpreted as a hybrid beam ID. The hybrid beam ID associates to a certain pair of an analog beam group ID and a digital beam ID.
The DU and RU infer both the analog beam group ID and the digital beam ID from the hybrid beam ID based on a predefined function or a mapping table. In this case, the analog beam group ID and the digital beam ID are not explicitly signaled in the C-plane.
The mapping table or predefined function is transferred through M-plane signaling in step 1 in FIG. 8 from the RU to the DU.
Once the analog beam group ID and the digital beam ID are derived, the RU routes the analog beam group ID and the digital beam ID into a different processer or dedicated integrated circuits.
The analog and digital BF weights are obtained, if the analog beam group ID and/or the digital beam ID have been associated with analog and/or digital BF weights.
The analog or digital BF weights are needed in the C-plane message only if the DU intends to associate with new weights to the analog beam group ID or the digital beam ID.
The bit-width of the hybrid beam ID is identified in the M-plane, and is not necessarily 15 bits as a default value.

FIG. 11 illustrates an example of a mapping from the hybrid beam ID to an analog beam group ID and a digital beam ID according to embodiments of the present disclosure. The embodiment of a mapping 1100 shown in FIG. 11 is for illustration only. FIG. 11 does not limit the scope of this disclosure to any particular mapping.

The mapping 1100 associates a hybrid beam ID 1101 with an analog beam group ID 1102 and a digital beam ID 1103. The analog beam group ID 1102 and the digital beam ID 1103 further locates the analog and digital beamforming, with the analog beam group ID 1102 mapping to an analog beam ID per transceiver 1104 and the analog beam group ID 1102 and the analog beam ID per transceiver 1104 collectively mapping to a set of analog beamforming weights per transceiver 1105. The digital beam ID 1103 maps to a set of digital beamforming weights per transceiver 1106. The beamforming configuration information is necessary when the hybrid beam ID to beamforming weights mappings are unknown or to be overwritten. Otherwise, such information exists at the RU and the DU does not need to send the information in the C-plane.

M-plane hybrid beam ID to analog beam group mapping configuration: In an embodiment, the mapping from the hybrid beam ID to the analog beam group ID and digital beam ID exists in the Yang model. The RU transfer the mapping through M-plane with the other hybrid BF related M-plane message in the step 1 of the FIG. 8.

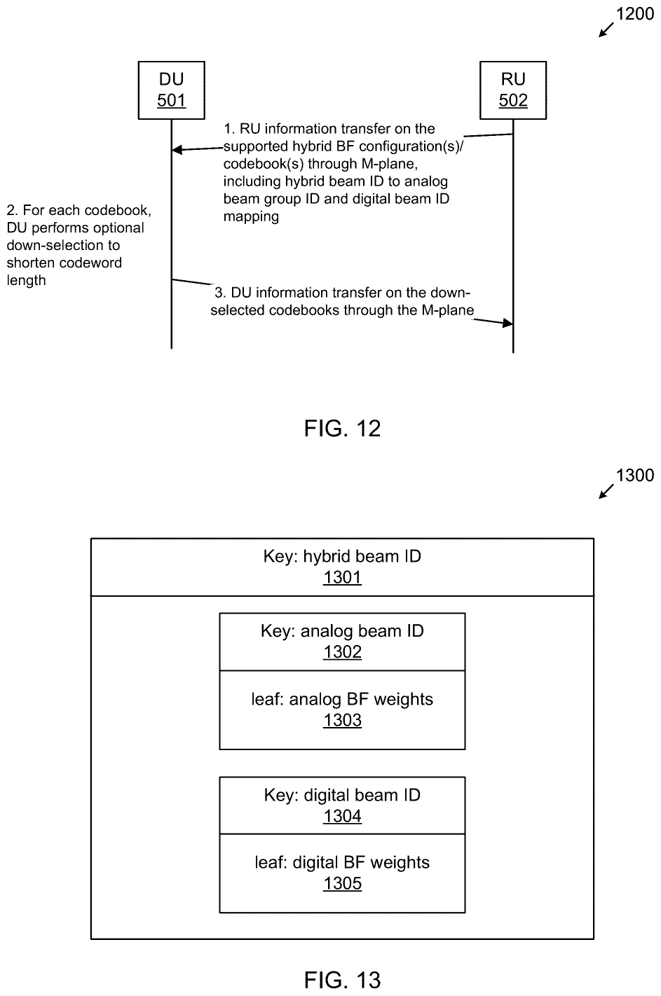

FIG. 12 is a signaling diagram illustrating an alternative example of hybrid beamforming for use in connection with the O-RAN fronthaul according to embodiments of the present disclosure. The embodiment of the signaling 1200 shown in FIG. 12 is for illustration only. FIG. 12 does not limit the scope of this disclosure to any particular implementation of signaling.

FIG. 12 is updated from FIG. 8 with a description of hybrid beam ID mapping transfer in step 1. The leaf “is-digital-analog-beam-id-coupled” of “hybrid-bf-configuration” in the YANG model is set as true, meaning that the digital beam ID and analog beam group ID are coupled as the hybrid beam ID in ST1.

M-plane hybrid beam ID mapping: In an embodiment, the hybrid beam ID is a composite of the analog beam group ID and the digital beam ID. For example, the hybrid beam ID has 15 bits, with the first 7 bits being the analog beam group ID and the last 8 bits being the digital beam ID.

In another embodiment, the hybrid beam ID is a function of the analog beam group ID and the digital beam ID. The mapping from the hybrid beam ID to the analog beam group ID and the digital beam ID are transferred through the M-plane or dynamically in the C-plane.

The RU transfers the mapping from the hybrid beam ID to the analog beam group ID and the digital beam ID to the DU through the M-plane. The analog beam group ID and the digital beam ID do not need to be explicitly transmitted.

In some embodiments, the mapping is formed in a list manner: a list of hybrid beam ID to analog beam group ID and digital beam ID as leafs. For example:

```
grouping hybrid-bf-configuration {
  ...
  leaf-list hybrid-beam-id-mapping {
    key hybrid-beam-id;
    leaf analog-beam-group-id {
      type uint16;
      description “the analog beam group ID.”;
    }
    list digital-beam-id {
      type uint16;
      description “the digital beam ID.”;
    }
    description “the hybrid beam ID.”;
  }
  ...
}
```

In some embodiment, the mapping is formed in a “list of lists” manner: a list of hybrid beam ID is transferred, each of the hybrid beam ID contains to two lists, one list for analog beam group ID and the other list for digital beam ID, as the example in FIG. 13.

FIG. 13 illustrates an example of an alternative mapping from the hybrid beam ID to an analog beam group ID and a digital beam ID according to embodiments of the present disclosure. The embodiment of a mapping 1300 shown in FIG. 13 is for illustration only. FIG. 13 does not limit the scope of this disclosure to any particular mapping.

The mapping 1300 associates a hybrid beam ID 1301 as a first key, with an analog beam group ID 1302 as a second key and analog beamforming weights 1303 as an associated leaf, and with a digital beam ID 1304 as a third key and digital beamforming weights 1305 as an associated leaf.

An example of the YANG model is shown below (the other leaf of the hybrid-bf-configuration uses the YANG model above):

```
grouping hybrid-bf-configuration {
  ...
  list hybrid-beam-id-mapping {
    key hybrid-beam-id;
      list analog-beam-group-id-mapping {
        key analog-beam-group-id;
        container analog-bf-weight {
          leaf analog-control-bit-vector {
            type uint16;
          }
        }
        description “the analog beam group ID.”;
      }
      list digital-beam-id-mapping {
        key digital-beam-id:
        container digital-bf-weight {
          leaf digital-bf-weight-i {
            type uint16;
          }
          leaf digital-bf-weight-q {
            type uint16;
          }
        }
        description “the analog beam group ID.”;
      }
      description “the hybrid beam ID.”;
    }
    ...
}
```

For example, there are 4 analog beam group IDs and 5 digital beam IDs in total. The hybrid beam ID is from 1 to 20, in which:
Hybrid beam ID: #1˜#5 refer to analog beam group ID=1 and digital beam IDs=1˜5;
Hybrid beam ID: #6˜#10 refer to analog beam group ID=2 and digital beam IDs=1˜5;
Hybrid beam ID: #11˜#15 refer to analog beam group ID=3 and digital beam IDs=1˜5;
Hybrid beam ID: #16˜#20 refer to analog beam group ID=4 and digital beam IDs=1˜5;
   Assume K=4 and K′=2, the hybrid beam ID to the analog beam group and the digital beam ID mapping in the JavaScript Object Notation (JSON) file is shown below, as one example. The “hybrid-beam-id-mapping” contains 20 mappings of the hybrid beam ID to the analog beam group and digital beam ID. The first five have the same analog beam group ID and analog control bit-vectors; the digital beam ID and digital BF weights are different. In the sixth “hybrid-beam-id”, the analog beam group ID becomes different from the first five; the digital beam ID is the same as the first “hybrid-beam-id”. In the last “hybrid-beam-id”, the analog beam group ID becomes different from the first fifteen “hybrid-beam-id”; the digital beam ID is the same as the fifth “hybrid-beam-id”:

```
.
“hybrid-bf-configuration”: {
  “hybrid-beam-id-mapping”: {
    {“hybrid-beam-id” : 0x00;
      “analog-beam-group-id-mapping”: {
        “analog-beam-group-id”: 00b;
        “analog-bf-weight”: [00, 00, 00, 00];
      }
      “digital-beam-id-mapping”: {
        “digital-beam-id”: 000b;
        “digital-bf-weight-i”: [0x00, 0x00];
        “digital-bf-weight-q”: [0x01, 0x01];
      }
    }
    {“hybrid-beam-id” : 0x01;
      “analog-beam-group-id-mapping”: {
        “analog-beam-group-id”: 00b;
        “analog-bf-weight”: [00, 00, 00, 00];
      }
      “digital-beam-id-mapping”: {
        “digital-beam-id”: 001b;
        “digital-bf-weight-i”: [0x01, 0x01];
        “digital-bf-weight-q”: [0x01, 0x01];
      }
    }
    {“hybrid-beam-id” : 0x02;
      “analog-beam-group-id-mapping”: {
        “analog-beam-group-id”: 00b;
        “analog-bf-weight”: [00, 00, 00, 00];
      }
      “digital-beam-id-mapping”: {
        “digital-beam-id”: 010b;
        “digital-bf-weight-i”: [0x10, 0x10];
        “digital-bf-weight-q”: [0x01, 0x01];
      }
    }
    {“hybrid-beam-id” : 0x03;
      “analog-beam-group-id-mapping”: {
        “analog-beam-group-id”: 00b;
        “analog-bf-weight”: [00, 00, 00, 00];
      }
      “digital-beam-id-mapping”: {
        “digital-beam-id”: 011b;
        “digital-bf-weight-i”: [0x11, 0x11];
        “digital-bf-weight-q”: [0x00, 0x00];
      }
    }
    {“hybrid-beam-id” : 0x04;
      “analog-beam-group-id-mapping”: {
        “analog-beam-group-id”: 00b;
        “analog-bf-weight”: [00, 00, 00, 00];
      }
      “digital-beam-id-mapping”: {
        “digital-beam-id”: 100b;
        “digital-bf-weight-i”: [0x00, 0x00];
        “digital-bf-weight-q”: [0x11, 0x11];
      }
    }
    {“hybrid-beam-id” : 0x05;
      “analog-beam-group-id-mapping”: {
        “analog-beam-group-id”: 01b;
        “analog-bf-weight”: [10, 00, 10, 00];
      }
      “digital-beam-id-mapping”: {
        “digital-beam-id”: 000b;
        “digital-bf-weight-i”: [0x00, 0x00];
        “digital-bf-weight-q”: [0x01, 0x01];
      }
    }
... ...
    {“hybrid-beam-id” : 0x14;
      “analog-beam-group-id-mapping”: {
        “analog-beam-group-id”: 11b;
        “analog-bf-weight”: [11, 01, 11, 01];
      }
      “digital-beam-id-mapping”: {
        “digital-beam-id”: 100b;
        “digital-bf-weight-i”: [0x00, 0x00];
        “digital-bf-weight-q”: [0x11, 0x11];
      }
    }
  }
}
```

In some embodiments, the mapping is formed through remote procedure call (RPC) in the YANG model. The analog beam group ID is derived from the hybrid beam ID as:

$$analog beam group ID = floor ( hybrid beam ID / 5 ) ,$$

where B=floor(A) rounds the elements of A to the nearest integers less than or equal to A.

The digital beam ID is derived from the hybrid beam ID as:
digital beam ID=mod(hybrid beam ID, 5),
   where the C=mod(A, B) function return the remainder after division (modulo operation), i.e.,

$$C = A - B * floor ( A / B ) .$$

The functional relationship among the analog beam group ID, the digital beam ID, and the hybrid beam ID are defined using the RPC. An example of the YANG model is shown below:

```
module hybrid-beam-id-decode {
  namespace “urn: hybrid-beam-id-decode”;
  prefix “hb”;
  rpc custom-operation {
    input {
      leaf hybrid-beam-id {
        type uint32;
        description “Input parameter X for the operation, which is The ID of the hybrid beam”;
      }
      leaf num-digital-beam-id {
        type uint32;
        description “Input parameter Y for the operation, which is the total number of digital beams”;
      }
    }
    output {
      leaf analog-beam-group-id {
        type uint32;
        description “ analog-beam-group-id equals to floor(X/Y).”;
      }
      leaf digital-beam-id {
        type uint32;
        description “ digital-beam-id equals to mod(X, Y).”;
      }
    }
        description “RPC operation interprets the hybrid beam ID to analog beam group ID and digital
      beam ID.”;
  }
}
```

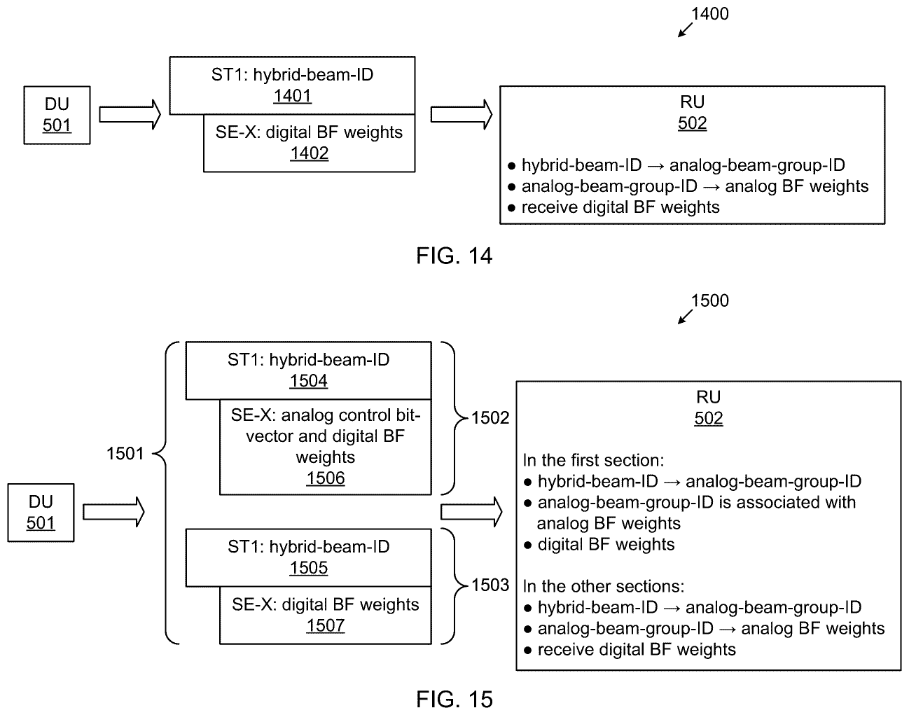

FIG. 14 illustrates an example of C-plane hybrid beamforming configuration with digital beamforming weights according to embodiments of the present disclosure. The embodiment of configuration 1400 shown in FIG. 14 is for illustration only. FIG. 14 does not limit the scope of this disclosure to any particular configuration.

C-plane hybrid BF configuration with digital BF weights: In some embodiments, the hybrid beam ID with dynamic digital BF weights is transferred in the C-plane from the DU to the RU. The analog beam group ID is inferred from the hybrid beam ID at the RU. The analog beam ID and the analog BF weights associated to the analog beam group ID are inferred by the RU.

In the example configuration 1400 illustrated in FIG. 14, the analog BF configuration fully exists in the hybrid beam ID 1401. For wideband digital beamforming (WDBF), the SE-X 1402 is used to transfer the digital beamforming weights.

FIG. 15 illustrates an example of C-plane hybrid beamforming configuration with analog and digital beamforming weights according to embodiments of the present disclosure. The embodiment of configuration 1500 shown in FIG. 15 is for illustration only. FIG. 15 does not limit the scope of this disclosure to any particular configuration.

C-plane hybrid beamforming configuration with analog and digital beamforming weights: The analog beam group ID mapping to the analog beam ID and/or analog beamforming weights may be dynamically configured in the C-plane message from the DU to the RU. When the analog beamforming configuration needs to be updated, the hybrid beam ID, the analog beam group ID, and the digital beam ID are explicitly contained in the same section description and transferred from the DU to the RU through the C-plane. The RU establishes the mapping for use in the rest of the section descriptions for future reuse, in some embodiments.

In the example illustrated in FIG. 15, the C-plane message 1501 is composed in a first section 1502 and other section(s) 1503 for other layers/subbands by ST1 1504, 1505 with SE-X 1506, 1507. The analog beam group ID in SE-X 1506, 1507 is disabled, but is interpretable from hybrid beam ID in ST1 1504, 1505. The SE-X 1506 for the first section 1502 includes an analog control bit-vector and digital beamforming weights, but the SE-X 1507 for other sections includes only the digital beamforming weights. That is, in the rest of the sections with the same analog beamforming configuration, the analog beamforming configuration is absent.

Two examples of the SE-X message for the first section and the other sections are shown in the TABLE 10 and TABLE 11, respectively:

TABLE 10
Section Extension X₃: hybrid beamforming weights configuration for the first section

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x0X₃ | | | | | | 1 | Octet N |
|---|---|---|---|---|---|---|---|---|
| extLen[15:0] | | | | | | | 2 | Octet |
| | | | | | | | | N + 1 |
| disableDigBfws = | RAD | disableDigBeamId = | disableAnaBfws = | disableAnaBeamId = | disableAnaBeamGroupId = | reserved | 1 | Octet |
| 0 | | 1 | 0 | 0 | 1 | (3bits) | | N + 3 |

| numBundPrb[7:0] | | var | Octet |
|---|---|---|---|
| | | | N + 4 |
| digBfwCompHdr[7:0] (for digital BF) | | var | Octet |
| | | | N + 5 |
| analogBeamId (for TRX K′) | | var | |
| tdBfParamPhase (for analog port 0 for TRX 0) | | var | |
| remaining beamforming weights bfwTheta up to K/K′ | | var | |
| analog port for TRX 0 | | | |
| . . . | | | |
| analog BeamId (for TRX K′) | | var | |
| tdBfParamPhase (for analog port 0 for TRX K′) | | var | |
| remaining beamforming weights bfwTheta up to K/K′ analog port for TRX K′ | | var | |
| digBfwCompParam (for PRB bundle 0) | | var | |
| contInd | bfwI (for digital port 0 and PRB bundle 0) | var | |
| bfwQ (for digital port 0 and PRB bundle 0) | | var | |
| remaining beamforming weights bfwI and bfwQ up to K′ | | var | |
| digital port and PRB bundle 0 | | | |
| digBfwCompParam (for PRB bundle 1) | | var | |
| contInd | bfwI (for digital port 0 and PRB bundle 1) | 1 | |
| bfwQ (for digital port 0 and PRB bundle 1) | | var | |
| remaining beamforming weights bfwI and bfwQ up to K′ | | var | |
| digital ports and PRB bundle 1 | | | |
| . . . | | | |
| digBfwCompParam (for last PRB bundle) | | var | |
| contInd | bfwI (for digital port 0 and last PRB bundle) | 1 | |

| | |
|---|---|
| bfwQ (for digital port 0 and last PRB bundle) | var |
| remaining beamforming weights bfwI and bfwQ up to K′ | var |
| digital ports and last PRB bundle | |
| zero pad to 4-byte boundary | var |

TABLE 11
Section Extension X₃: hybrid beamforming weights configuration for other sections

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x0X₃ | | | | | | 1 | Octet |
|---|---|---|---|---|---|---|---|---|
| | | | | | | | | N |
| extLen[15:0] | | | | | | | 2 | Octet |
| | | | | | | | | N + 1 |
| disableDigBfws = | RAD | disable DigBeamId = | disableAnaBfws = | disableAnaBeamId = | disableAnaBeamGroupId = | reserved | 1 | Octet |
| 0 | | 1 | 0 | 0 | 1 | (3bits) | | N + 3 |

| numBundPrb[7:0] | | var | Octet |
|---|---|---|---|
| | | | N + 4 |
| digBfwCompHdr[7:0] (for digital BF) | | var | Octet |
| | | | N + 5 |
| digBfwCompParam (for PRB bundle 0) | | var | |
| contInd | bfwI (for digital port 0 and PRB bundle 0) | var | |
| bfwQ (for digital port 0 and PRB bundle 0) | | var | |
| remaining beamforming weights bfwI and bfwQ up to K′ | | var | |
| digital port and PRB bundle 0 | | | |
| digBfwCompParam (for PRB bundle 1) | | var | |
| contInd | bfwI (for digital port 0 and PRB bundle 1) | 1 | |
| bfwQ (for digital port 0 and PRB bundle 1) | | var | |
| remaining beamforming weights bfwI and bfwQ up to K′ | | var | |
| digital ports and PRB bundle 1 | | | |
| . . . | | | |
| digBfwCompParam (for last PRB bundle) | | var | |
| contInd | bfwI (for digital port 0 and last PRB bundle) | 1 | |

| | |
|---|---|
| bfwQ (for digital port 0 and last PRB bundle) | var |
| remaining beamforming weights bfwI and bfwQ up to K′ | var |
| digital ports and last PRB bundle | |
| zero pad to 4-byte boundary | var |

A variation of the SE-X3 from the SE-X in TABLE 2 is adding “disableAnaBeamGroupId”. Since the analog beam group ID is interpreted in the second embodiment, the analog beam group ID can be disabled by “disableAnaBeamGroupId = 1”.

In a third embodiment:
The digital beamforming configuration is transferred through an existing SE, such as SE1 and SE11.
The analog beamforming configuration is signaled in a section extension or section type, independent from the digital beamforming.
The RU applies the latest analog beamforming configuration, until a new analog beamforming configuration is received from the DU through C-plane—meaning that the section extension for the analog beamforming configuration is sent by the DU when a change of analog beamforming is required.

Analog configuration through section extension: In an embodiment, the analog beam group ID, analog beam ID, and analog control bit-vectors are transferred in a section extension, as shown in TABLE 12:

TABLE 12
Section Extension Y: analog beamforming weights configuration

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x0Y | 1 | Octet |
|---|---|---|---|
| | | | N |
| extLen[15:0] | | 2 | Octet |
| | | | N + 1 |
| disableAnaBfws = | analogBeamGroupId[14:8] | 1 | |
| 0 | | | |

| | |
|---|---|
| analogBeamGroupId[7:0] | 1 |
| analogBeamId (for TRX 0) | var |
| tdBfParamPhase (for analog port 0 for TRX 0) | var |
| remaining beamforming weights bfwTheta up to K/K′ | var |
| analog port and TRX 0 | |
| . . . | |
| analogBeamId (for TRX K′) | var |
| tdBfParamPhase (for analog port 0 for TRX K′) | var |
| remaining beamforming weights bfwTheta up to K/K′ | var |
| analog port and TRX K′ | |
| zero pad to 4-byte boundary | var |

The control bit-vectors can be disabled by “disableAnaBfws”.

In another embodiment, the analog beam group ID and analog control bit-vectors are transferred in a section extension, as shown in TABLE 12. The control bit-vectors can be disabled by “disableAnaBlfws”, as shown in TABLE 13:

TABLE 13
Section Extension Y₁: analog BF weights configuration

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| | | | |
|---|---|---|---|
| ef | extType = 0x0Y₁ | 1 | Octet |
| | | | N |

| extLen[15:0] | | 2 | Octet |
|---|---|---|---|
| | | | N + 1 |
| disableAnaBfws = 1 | analogBeamGroupId[14:8] | 1 | |

| | |
|---|---|
| analog BeamGroupId[7:0] | 1 |
| zero pad to 4-byte boundary | var |

With “disableAnaBlfws=1”, the analog control bit-vectors are absent in the SE-Y₁. The DU only configures the analog beam group ID to the RU.

When the second embodiment is applied, i.e., the analog beam group ID is inferred from the hybrid beam ID, the SE-Y₂ shown in TABLE 14 transfers the analog beam ID and control bit-vectors from the DU to the RU:

TABLE 14
Section Extension Y₂: analog beamforming weights configuration
with analog beam ID and control bit-vectors

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| | | | |
|---|---|---|---|
| ef | extType = 0x0Y₂ | 1 | Octet |
| | | | N |

| | | |
|---|---|---|
| extLen[15:0] | 2 | Octet |
| | | N + 1 |
| analogBeamld (for TRX 0) | var | |
| tdBfParamPhase (for analog port 0 for TRX 0) | var | |
| remaining beamforming weights bfwTheta up to K/K′ | var | |
| analog port and TRX 0 | | |
| . . . | | |
| analogBeamId (for TRX K′) | var | |
| tdBfParamPhase (for analog port 0 for TRX K′) | var | |
| remaining beamforming weights bfwTheta up to K/K′ | var | |
| analog port and TRX K′ | | |
| zero pad to 4-byte boundary | var | |

An embodiment transferring only analog control bit-vectors is shown in TABLE 15:

TABLE 15
Section Extension Y₃: analog beamforming weights
configuration with analog control bit-vectors

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| | | | |
|---|---|---|---|
| ef | extType = 0x0Y₂ | 1 | Octet |
| | | | N |

| | | |
|---|---|---|
| extLen[15:0] | 2 | Octet |
| | | N + 1 |
| tdBfParamPhase (for analog port 0 for TRX 0) | var | |
| remaining beamforming weights bfwTheta up to K/K′ | var | |
| analog port and TRX 0 | | |
| . . . | | |
| tdBfParamPhase (for analog port 0 for TRX K′) | var | |
| remaining beamforming weights bfwTheta up to K/K′ | var | |
| analog port and TRX K′ | | |
| zero pad to 4-byte boundary | var | |

The control bit-vectors for the K phase-shifters are signaled in the SE-Y₃ in a queue.

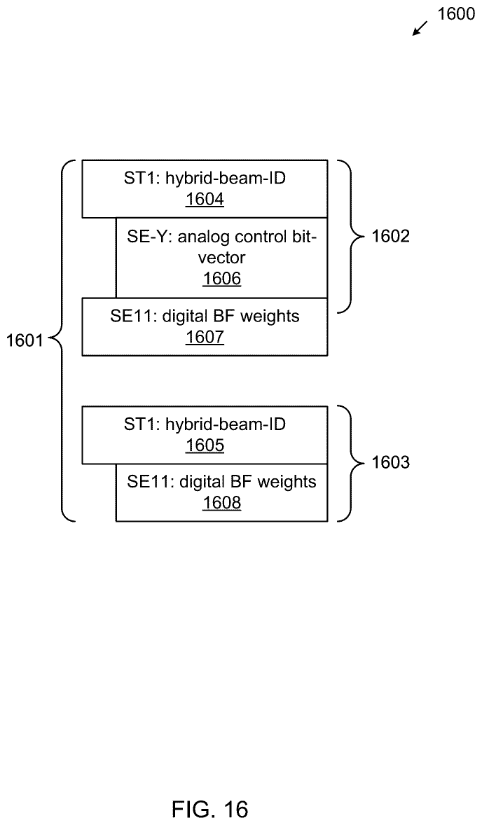

FIG. 16 illustrates an example of C-plane hybrid beamforming configuration with analog and digital beamforming weights according to embodiments of the present disclosure. The embodiment of configuration 1600 shown in FIG. 16 is for illustration only. FIG. 16 does not limit the scope of this disclosure to any particular configuration.

The C-plane message for hybrid BF using SE-Y is shown in FIG. 16. In the example illustrated in FIG. 16, the C-plane message 1601 is composed in a first section 1602 and other section(s) 1603 for other layers/subbands by ST1 1604, 1605 with SE-Y 1606 and SE11 1607, 1608. In the first section 1602, the hybrid beam ID is transferred in the first section in ST1 1604 from the DU to the RU. SE-Y 1606 (or SE-Y₁, SE-Y₂, SE-Y₃ depending the scenario) is used for analog BF weights configuration. SE11 1607, 1608 is used for digital beamforming weights configuration. In the other sections 1603 within the ST1 1605, the hybrid beam IDs in the section description have the same analog beam group ID. The digital beam ID may vary. The digital beamforming weights are transmitted in the SE11.

Analog configuration through section type: In an embodiment, the analog beam group ID is transmitted using a section type. An example is shown in TABLE 16:

TABLE 16
Section Type Y: analog beam group ID configuration

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| transport header: see clause 5.1.3 | | | 8 | Octet 1 |
|---|---|---|---|---|
| dataDirection | payloadVersion | filterIndex | 1 | Octet 9 |

| frameID | | 1 | Octet 10 |
|---|---|---|---|
| subframeID | slotId | 1 | Octet 11 |

| | | | |
|---|---|---|---|
| slotId | startSymbolID | 1 | Octet 12 |

| numberOfsections | | | | 1 | Octet 13 |
|---|---|---|---|---|---|
| sectionType = Y | | | | 1 | Octet 14 |
| udCompHdr | | | | 1 | Octet 15 |
| reserved | | | | 1 | Octet 16 |
| sectionId | | | | 1 | Octet 17 |
| sectionId | rb | symInc | startPrbc | 1 | Octet 18 |

| startPrbc | | 1 | Octet 19 |
|---|---|---|---|
| numPrbc | | 1 | Octet 20 |
| reMask[11:4] | | 1 | Octet 21 |
| reMask[3:0] | numSymbol | 1 | Octet 22 |

| | | | |
|---|---|---|---|
| ef | analogBeamGroupld[14:8] | 1 | Octet 23 |

| | | |
|---|---|---|
| analogBeamGroupId[7:0] | 1 | Octet 24 |
| Section Extensions as indicated by ‘ef’ | var | |

In the scenario that the analog control bit-vector is needed, the SE-Y₃ in TABLE 15 can be used.

The current O-RAN CUS plane specification [1] supports flexible sending of beamforming weights from the O-DU to the O-RU using SE11 along with ST1. This enables the O-DU to provide different beamforming weights for different PRBs within one section to facilitate, e.g., zero-forcing precoding. The O-DU provides the numBundPrb parameter, which informs the O-RU how many PRBs are bundled together and share the same beamforming weights. TABLES 17 and 18 depict SE 11 as in the current specification:

TABLE 17
SE 11 with disableBFWs = 0.

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x0B | | 1 | Octet |
|---|---|---|---|---|
| | | | | N |
| extLen[15:0] | | | 2 | Octet |
| | | | | N + 1 |
| disableBFWs = 0 | RAD | reserved (6 bits) | 1 | Octet |
| | | | | N + 3 |

| numBundPrb[7:0] | | 1 | Octet |
|---|---|---|---|
| | | | N + 4 |
| bfwCompHdr[7:0] | | 1 | Octet |
| | | | N + 5 |
| bfwCompParam (for PRB bundle 0) | | var | Octet |
| | | | N + 6 |
| contInd | beamId[14:8] (for PRB bundle 0) | 1 | |
| beamId[7:0] (for PRB bundle 0) | | 1 | |
| bfwI (for TRX 0 and PRB bundle 0) | | var | |
| bfwQ (for TRX0 and PRB bundle 0) | | var | |
| remaining beamforming weights bfwI and bfwQ up to | | var | |
| L TRXs and PRB bundle 0 | | | |
| bfwCompParam (for PRB bundle 1) | | var | |
| contInd | beamId[14:8] (for PRB bundle 1) | 1 | |
| beamId[7:0] (for PRB bundle 1) | | 1 | |
| bfwI (for TRX 0 and PRB bundle 1) | | var | |
| bfwQ (for TRX0 and PRB bundle 1) | | var | |
| remaining beamforming weights bfwI and bfwQ up to | | var | |
| L TRXs and PRB bundle 1 | | | |
| . . . | | | |
| bfwCompParam (for last PRB bundle) | | var | |
| contInd | beamId[14:8] (for last PRB bundle) | 1 | |

| | |
|---|---|
| beamId[7:0] (for last PRB bundle) | 1 |
| bfwI (for TRX 0 and last PRB bundle) | var |
| bfwQ (for TRX0 and last PRB bundle) | var |
| remaining beamforming weights bfwI and bfwQ up to | var |
| L TRXs and last PRB bundle | |
| zero pad to 4-byte boundary | var |

TABLE 18
SE 11 with disableBFWs = 1.

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x0B | | 1 | Octet |
|---|---|---|---|---|
| | | | | N |
| extLen[15:0] | | | 2 | Octet |
| | | | | N + 1 |
| disableBFWs | RAD | reserved (6 bits) | 1 | Octet |
| | | | | N + 3 |

| numBundPrb[7:0] | | 1 | Octet |
|---|---|---|---|
| | | | N + 4 |
| contInd | beamId[14:8] (for PRB bundle 0) | 1 | |
| beamId[7:0] (for PRB bundle 0) | | 1 | |
| contInd | beamId[14:8] (for PRB bundle 1) | 1 | |
| beamId[7:0] (for PRB bundle 1) | | 1 | |
| . . . | | | |
| contInd | beamId[14:8] (for last PRB bundle) | 1 | |

| | |
|---|---|
| beamId[7:0] (for last PRB bundle) | 1 |
| zero pad to 4-byte boundary | var |

JPTA beamforming requires the network to configure delays and phases for subband-specific beamforming. Current O-RAN specifications related to beamforming weights transfer between DU and RU do not support beamforming in terms of delays and phases. Therefore, a JPTA-specific fronthaul payload needs to be constructed for low-overhead transmission of beamforming parameters between the DU and RU.

This disclosure proposes procedures and payload structure for fronthaul signaling needed to realize JPTA beamforming. Following are the aspects involved in the signaling:
RU capability signaling. The RU signals the RU's capabilities to the DU through M-plane signaling. For JPTA beamforming, this signaling will include minimum supported delay, supported delay resolution, maximum number of JPTA beams, and other related parameters.
DU processing. DU takes RU capability as input and selects a subset of parameter values to be used for transmission. The parameters to be selected include the number of delay elements, bit resolution of delays, bit width of delays, minimum delay, and choice of the maximum number of JPTA beams (or, equivalently, the bit width of JPTA beam IDs).
Parameter set signaling from DU to RU. DU transmits parameter configuration files to RU using M-plane signaling. For example, the delay parameters are conveyed through the yang grouping called jpta-delay-parameters.
JPTA beamforming configuration per UE/layer. At each scheduling opportunity, the DU transmits UE-specific beamforming configuration to RU. This is achieved through C-plane signaling using section types and extensions.

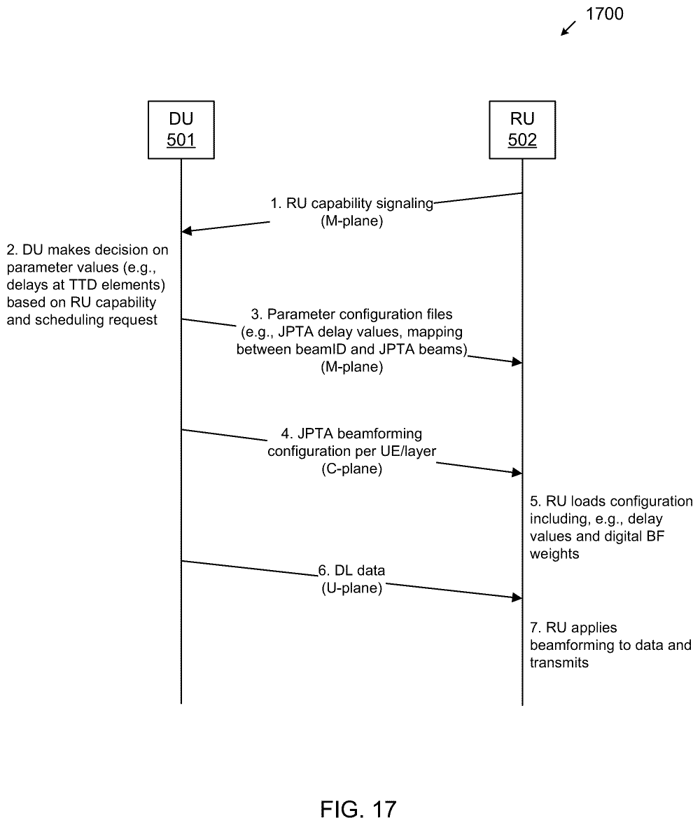

FIG. 17 is a signaling diagram illustrating an example of fronthaul processing steps for use in connection with the O-RAN fronthaul for JPTA according to embodiments of the present disclosure. The embodiment of the signaling 1700 shown in FIG. 17 is for illustration only. FIG. 17 does not limit the scope of this disclosure to any particular implementation of signaling.

FIG. 17 captures the overall fronthaul processing steps for beamforming and UE data transmission, mainly covering RU capability signaling, parameter set signaling from DU to RU, and UE/layer-specific JPTA beamforming configuration transfer. At step 1, RU capability is signaled from the RU to the DU on the M-plane. At step 2, the DU makes a decision on parameter values such as delays at true time delay (TTD) elements) based on the RU capability and a scheduling request. At step 3, parameter configuration files, such as JPTA delay values and a mapping between beamID and JPTA beams, are transferred from the DU to the RU on the M-plane. At step 4, a JPTA beamforming configuration per UE/layer is transferred from the DU to the RU on the C-plane. At step 5, the RU loads the beamforming configuration, such as the delay values and digital beamforming values. At step 6, downlink data is transferred from the DU to the RU on the U-plane. At step 7, the RU applies beamforming to the received data and transmits.

RU capability signaling. The RU will signal supported parameter values to the DU through M-plane signaling. For example, RU capability signaling may include the minimum supported delay, the bit precision of delay values, and the maximum supported bit width, as well as delay dimensioning parameters such as the positions of delay elements and the number of rows and columns of delay elements. Example 1-1 shows a sample YANG grouping to realize delay parameters signaling.

### Example 1-1. Delay Parameters Signaling

```
grouping jpta-delay-parameters {
  leaf num-delay-element {
    type uint16 {
      range “1..65535”;
    }
    mandatory true;
    description
      “Maximum number of supported delay elements”;
  }
  leaf num-delay-element-rows {
    type uint16 {
      range “1..65535”;
    }
    mandatory true;
    description
      “Maximum number of rows of delay elements”;
  }
  leaf num-delay-element-columns {
    type uint 16 {
      range “1..65535”;
    }
    mandatory true;
    description
      “Maximum number of columns of delay elements”;
  }
  leaf delay-bitwidth {
    type uint4 {
      range “1..15”;
    }
    default 2;
    description
      “Bit-width for delay at each element”;
  }
  leaf delay-bitprecision {
    type uint4 {
      range “1..15”;
    }
    mandatory true;
    description
      “Bit precision of TTD delays supported by RU. Unit is 0.1 ns”;
  }
  leaf delay-min {
    type uint4 {
      range “1..15”;
    }
    units half-nanoseconds;
    mandatory true;
    description
      “Min delay value supported by RU”;
  }
  description “Common jpta beamforming delay parameters.”;
}
```

Common beamforming parameters configuration. Based on the RU capability signaling, the DU makes a decision on common beamforming parameters to be used, including delay parameters for JPTA, and transmits this information to the RU. The choice of common parameters may define a mapping between bits transmitted through control signaling and specific beamforming parameter values. For example, to indicate delay value at a specific TTD element, let b be the sequence of bits transmitted (of length equal to the chosen bit width w), τₘᵢₙ be the selected minimum delay from M-plane, and τ_{prec.} be the selected bit precision of delay from M-plane. Then the actual delay value corresponding to the bit sequence b will be given by

$$τ ( b ) = {τ}_{min} + {τ}_{prec .} \cdot D ( b )$$

where D(b) is a function that converts a bit sequence b to the corresponding decimal integer. In some embodiments, b is transmitted in C-plane and in some others in M-plane.

The RU reports capability on JPTA beam ID length and the DU confirms or down-selects the specific choice of JPTA beam ID length (for example, down-selection between 7 bits and 15 bits) as part of common beamforming parameters configuration. Choice of these additional common beamforming parameters determine the payload size for conveying beamforming information per UE through C-plane signaling.

Beamforming parameters per UE. Specific beamforming parameters per UE may be indicated by the DU through C-plane signaling, which is achieved using the proposed Section Extension (SE) N (described below) along with ST1.

The beamforming parameters can be indicated through explicit signaling as part of SE N, or can be pre-configured in the M-plane through JPTA beam IDs. TABLE 19 depicts a structure of the proposed SE N, where the beamforming parameters are indicated explicitly:

TABLE 19
Section Extension N

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x . . . | 1 | Octet |
|---|---|---|---|
| | | | N |
| extLen[15:0] | | 2 | Octet |
| | | | N + 1 |
| disableBFWs = 0 | numBundPrb | 1 | Octet |
| | | | N + 3 |
| bfwCompHdr | | 1 | Octet |
| | | | N + 4 |
| reserved | symbolMask[13:8] | 1 | Octet |
| | | | N + 5 |
| symbolMask[7:0] | | 1 | Octet |
| | | | N + 6 |
| tdbfParamDelay (for element 0) | | var | Octet |
| | | | N + 7 |
| tdbfParamDelay (for element 1) | | var | |
| . . . | | | |
| tdbfParamDelay (for element K_{d} − 1) | | var | |
| tdbfParamPhase (for element 0) | | var | |
| tdbfParamPhase (for element 1) | | | |
| . . . | | | |
| tdbfParamPhase (for element Kₚ − 1) | | var | |
| contInd | bfw for PRB bundle 0 | var | |
| contInd | bfw for PRB bundle 1 | var | |
| . . . | | | |
| contInd | bfw for PRB bundle R-1 | var | |

| | |
|---|---|
| zero pad to 4-byte boundary | var |

The choice to explicitly indicated beamforming parameters is indicated by setting disableBFWs to 0. In this case, SE N includes explicit indication of delays and phases for JPTA beamforming, as well as digital beamforming weights for each PRB bundle.

TABLE 20 depicts a structure of the proposed SE N, where JPTA beam IDs are included in the section extension, instead of explicit indication of beamforming parameters:

TABLE 20
Section Extension N

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| ef | extType = 0x . . . | 1 | Octet |
|---|---|---|---|
| | | | N |
| extLen[15:0] | | 2 | Octet |
| | | | N + 1 |
| disableBFWs = 1 | numBundPrb | 1 | Octet |
| | | | N + 3 |

| | | | |
|---|---|---|---|
| reserved | symbolMask[13:8] | 1 | Octet |
| | | | N + 4 |

| symbolMask[7:0] | | 1 | Octet |
|---|---|---|---|
| | | | N + 5 |
| contInd | jptabeamId for PRB bundle 0 | var | Octet |
| | | | N + 6 |
| contInd | jptabeamId for PRB bundle 1 | var | |
| . . . | | | |
| contInd | jptabeamId for PRB bundle R-1 | var | |

| | |
|---|---|
| zero pad to 4-byte boundary | var |

The choice not to explicitly indicate beamforming parameters is indicated by setting disableBFWs to 1.

Following are the fields included in SE N:
ef (extension flag). This parameter is used to indicate if there is another extension present (ef=1) or this is the last extension (ef=0), same as current O-RAN CUS plane specification [1].
exType (extension type). 7-bit field denoting the SE type.
exLen (extension length). This parameter provides the length of the SE in units of 32-bit (or 4-byte) words, same as current O-RAN CUS plane specification [1]. The value zero is reserved, as there is always at least one word in the extension (the word containing the extType and extLen).
disableBFWs (disable beamforming weights). This parameter is used to indicate whether delays, phases, and digital beamforming weights are explicitly indicated as part of the SE (disableBFWs=0) or by transmitting pre-configured JPTA beam IDs (disableBFWs=1).
numBundPrb (Size of each PRB bundle). This 8-bit field represents the number of PRBs in each PRB bundle, i.e., the number of PRBs sharing the same digital beamforming weights, same as current O-RAN CUS plane specification [1]. The number of PRB bundles (R) should be equal to the total number of PRBs selected by section description in the C-Plane message (e.g., using the fields startPrbc and numPrbc in ST1), divided by numBundPrb. When the division outcome is fractional value, R is obtained by taking the ceiling of this value (i.e., one additional beamforming weight for each respective transceiver), in order to cover the orphan PRBs.
bfwCompHdr (compression header for digital beamforming weights).
symbolMask (symbol bit mask). This parameter is a bit mask where each bit indicates whether the SE applies to a given symbol in the slot.
tdbfParamDelay (delay at each delay element).
tdbfParamPhase (phase at each phase shifter).
contInd (PRB region continuity flag).
bfw (digital beamforming weights per PRB bundle).

For this case, the mapping between JPTA beam IDs and delay and phase values will be configured in the M-plane. Example 1-2 shows an example of a yang grouping to configure this mapping.

### Example 1-2. JPTA Beam ID Mapping

```
container jptabeamId-codebook {
  list jptabeamId {
    key beam-id;
    leaf bit-vector-config {
      type uint16;
    }
    description “The beam ID for JPTA. The effective beam ID is on the LSBs.”;
  }
}
```

Example 1-3 shows a sample payload using SE N for JPTA beamforming. Suppose the gNB JPTA architecture 450 in FIG. 4A has five delay elements (K_{d}=5) numbered 0, 1, 2, 3, 4, at which delay values need to be reported, and four phase shifters (Kₚ=4) numbered 0, 1, 2, 3, at which delay values need to be reported. TABLE 21 captures the delay values in nanoseconds (ns) and TABLE 22 captures the phase values in degrees (deg.) at element:

TABLE 21
Delay values at each delay element

| | Element 0 | Element 1 | Element 2 | Element 3 | Element 4 |
|---|---|---|---|---|---|
| Delays (ns) | 0.5 | 1.7 | 2.5 | 0.9 | 1.3 |

TABLE 22
Phase values at each phase shifter

| | PS 0 | PS 1 | PS 2 | PS 3 |
|---|---|---|---|---|
| Phases (deg) | 0 | 90 | 180 | 270 |

Further assume the M-plane parameters are configured as in TABLE 23:

TABLE 23
M-plane parameters

| | |
|---|---|
| num-delay-element | 5 |
| delay-min (ns) | 0.5 |
| delay-bitprecision (ns) | 0.1 |
| delay-bitwidth | 6 |
| Num-phase-shifter | 4 |
| phase-min (deg.) | 0 |
| phase-bitprecision (deg.) | 2 |
| phase-bitwidth | 8 |

Then with disableBFWs set to 0, the following will be the payload for SE N:

TABLE 24
Example payload for SE N

| Field | Bits |
|---|---|
| disableBFWs | 1 |
| tdbfParamDelay (for element 0) | 000000 |
| tdbfParamDelay (for element 1) | 001100 |
| tdbfParamDelay (for element 2) | 010100 |
| tdbfParamDelay (for element 3) | 000100 |
| tdbfParamDelay (for element 4) | 001000 |
| tdbfParamPhase (for ps 0) | 00000000 |
| tdbfParamPhase (for ps 1) | 00101101 |
| tdbfParamPhase (for ps 2) | 01011010 |
| tdbfParamPhase (for ps 3) | 10000111 |

In a second alternative embodiment, JPTA beamforming parameters per UE are conveyed through enhancements to existing Section Type 4 in the current O-RAN CUS plane specification [1]. In this case, a JPTA beam ID with configurable bit width corresponds to a set of delay and phase values, and the digital beamforming weights are defined for each PRB bundle. The mapping between JPTA beam IDs and a tuple of K_{d} delay values and Kₚ phase values is defined in the M-plane, similar to Example 1-2.

TABLE 25 depicts the proposed enhanced Section Type 4:

TABLE 25
Enhanced ST 4 for JPTA beamforming configuration
st4CmdType ‘JPTA_BEAM_CONFIG’

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| transport header | | 8 | Octet 1 |
|---|---|---|---|
| Section Type 4 section header | | 8 | Octet 9 |
| Section Type 4 common part of the command header | | 8 | Octet 17 |
| reserved | symbolMask[13:8] | 1 | Octet 25 |

| | | |
|---|---|---|
| symbolMask[7:0] | 1 | Octet 26 |
| jpta-beamID | var | |
| bfwCompHdr | 1 | |
| numPrbBundles | var | |
| prbBundleSize | var | |
| startPrbc | var | |
| bfwCompParam | var | |
| bfw for PRB bundle 0 | var | |
| bfw for PRB bundle 1 | var | |
| . . . | | |
| bfw for PRB bundle R-1 | var | |
| zero pad to a 4-byte boundary | var | |

“Section Type 4 common part of the command header” is the same as the current O-RAN CUS plane specification [1]. st4CmdType=5 shall be set for st4CmdType: JPTA_BEAM_CONFIG.

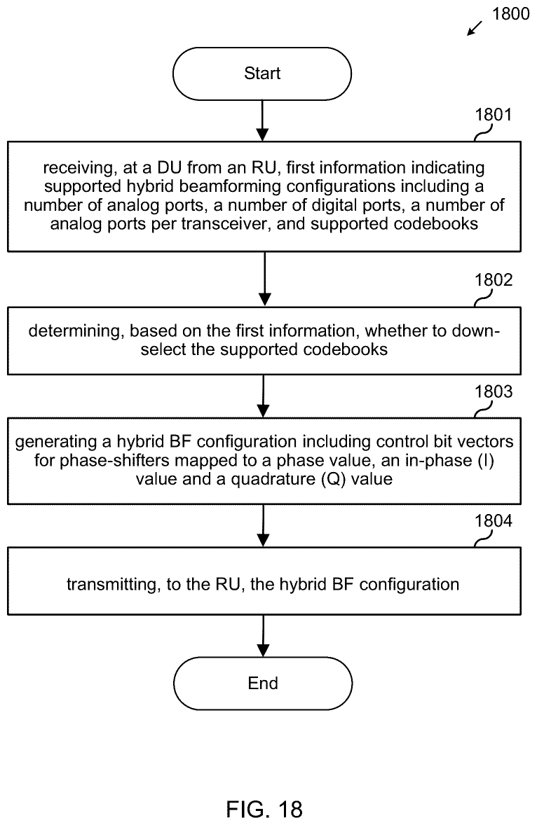

FIG. 18 is a high level flowchart of a process of hybrid beamforming configuration in accordance with embodiments of the present disclosure. The process 1800 illustrated in FIG. 18 is for illustration only, and FIG. 18 does not limit the scope of this disclosure to any particular implementation. The process 1800 may be performed by either the controller/processor 340 in FIG. 3A or the controller/processor 378 of FIG. 3B, in connection with the beamforming architecture 400 of FIG. 4 and/or in the DU 501 of FIG. 5.

The process 1800 receiving, from RU 502, information indicating supported hybrid beamforming (BF) configurations, including a number of analog ports, a number of digital ports, a number of analog ports per transceiver, and supported codebooks (block 1801). The DU 501 determines, based on the information, whether to down-select the supported codebooks (block 1802), and generates a hybrid BF configuration including control bit vectors for phase-shifters mapped to a phase value, an I value and a Q value (block 1803). The DU 501 transmits, to the RU 502, the hybrid BF configuration (block 1804).

Although FIG. 18 illustrates one example process 1800, various changes may be made to FIG. 18. For example, while shown as a series of steps, various steps in FIG. 18 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of operating a distributed unit (DU), the method comprising:
receiving, from a radio unit (RU), first information indicating supported hybrid beamforming (BF) configurations, wherein the first information includes a number of analog ports, a number of digital ports, a number of analog ports per transceiver (TRX), and supported codebooks;
determining, based on the first information, whether to down-select the supported codebooks;
generating a hybrid BF configuration; and
transmitting, to the RU, the hybrid BF configuration,
wherein the hybrid BF configuration includes control bit vectors for phase-shifters, and
wherein a control bit vector, from the control bit vectors, is mapped to a phase value, an in-phase (I) value and a quadrature (Q) value.

2. The method of claim 1, wherein the hybrid BF configuration includes an analog BF configuration that applies to a frequency band and a digital BF configuration that applies to a subband within the frequency band.

3. The method of claim 1, further comprising:
generating a control message comprising:
a tdBfParamPhase field indicating the control bit vector,
a disableDigBeamId field indicating whether digital beam identifiers (IDs) are disabled, and
a disableAnaBeamId field indicating whether analog bean IDs are disabled,
wherein the tdBfParamPhase field is 4 bits,
wherein transmitting the hybrid BF configuration further comprises transmitting the control message.

4. The method of claim 1, further comprising:
receiving, from the RU, second information indicating capabilities related to beamforming, wherein the second information includes a minimum supported delay, a supported delay resolution, and a supported maximum number of beams; and
determining, based on the second information, parameters related to BF, wherein the parameters include third information related to a number of delay elements, bit resolution of the delay elements, bit width of the delay elements, a minimum delay, and a maximum number of beams,
wherein transmitting the hybrid BF configuration further comprises transmitting the parameters for BF.

5. The method of claim 4, further comprising:
generating a control message comprising:
a section extension type field indicating a section extension type used for the parameters for beamforming,
a disableBFWs field indicating whether the parameters for beamforming are explicitly indicated,
a numBundPrb field indicating a number of physical resource blocks (PRBs) in each PRB bundle,
a symbolMask field indicating a bit mask that indicates whether the section extension type is applicable to a symbol in a slot,
a tdbfParamDelay field indicating a delay at each of the delay elements,
a tdbfParamPhase field indicating a phase at each phase shifter, and
a bfw field indicating beamforming weights for each of the PRB bundle,
wherein transmitting the hybrid BF configuration further comprises transmitting the control message.

6. The method of claim 1, wherein the hybrid BF configuration include a section extension X (SE-X) and a digital BF configuration.

7. The method of claim 1, wherein the hybrid BF configuration includes joint phase-time array (JPTA) beam identifiers (IDs) mapped to delay and phase values.

8. A distributed unit (DU), comprising:
a transceiver configured to receive, from a radio unit (RU), first information indicating supported hybrid beamforming (BF) configurations, wherein the first information includes a number of analog ports, a number of digital ports, a number of analog ports per transceiver (TRX), and supported codebooks; and
a controller configured to
determine, based on the first information, whether to down-select the supported codebooks,
generate a hybrid BF configuration,
wherein the transceiver is configured to transmit, to the RU, the hybrid BF configuration,
wherein the hybrid BF configuration includes control bit vectors for phase-shifters, and
wherein a control bit vector, from the control bit vectors, is mapped to a phase value, an in-phase (I) value and a quadrature (Q) value.

9. The DU of claim 8, wherein the hybrid BF configuration includes an analog BF configuration that applies to a frequency band and a digital BF configuration that applies to a subband within the frequency band.

10. The DU of claim 8, wherein the controller is configured to generate a control message comprising:
a tdBfParamPhase field indicating the control bit vector,
a disableDigBeamId field indicating whether digital beam identifiers (IDs) are disabled, and
a disableAnaBeamId field indicating whether analog bean IDs are disabled,
wherein the tdBfParamPhase field is 4 bits, and
wherein transceiver is configured transmit the control message.

11. The DU of claim 8, wherein the transceiver is configured to receive, from the RU, second information indicating capabilities related to beamforming, wherein the second information includes a minimum supported delay, a supported delay resolution, and a supported maximum number of beams,
wherein the controller is configured to determine, based on the second information, parameters related to BF, wherein the parameters include third information related to a number of delay elements, bit resolution of the delay elements, bit width of the delay elements, a minimum delay, and a maximum number of beams, and
wherein the transceiver is configured to transmit the parameters for BF.

12. The DU of claim 11, wherein the controller is configured to generate a control message comprising:
a section extension type field indicating a section extension type used for the parameters for beamforming,
a disableBFWs field indicating whether the parameters for beamforming are explicitly indicated,
a numBundPrb field indicating a number of physical resource blocks (PRBs) in each PRB bundle,
a symbolMask field indicating a bit mask that indicates whether the section extension type is applicable to a symbol in a slot,
a tdbfParamDelay field indicating a delay at each of the delay elements,
a tdbfParamPhase field indicating a phase at each phase shifter, and
a bfw field indicating beamforming weights for each of the PRB bundle,
wherein the transceiver is configured to transmit the control message.

13. The DU of claim 8, wherein the hybrid BF configuration include a section extension X (SE-X) and a digital BF configuration.

14. The DU of claim 8, wherein the hybrid BF configuration includes joint phase-time array (JPTA) beam identifiers (IDs) mapped to delay and phase values.

15. A radio unit (RU), comprising:
a controller configured to control beamforming; and
a transceiver configured to receive, from a distributed unit (DU), first information indicating supported hybrid beamforming (BF) configurations, wherein the first information includes a number of analog ports, a number of digital ports, a number of analog ports per transceiver (TRX), and supported codebooks,
wherein whether to down-select the supported codebooks is determined and a hybrid BF configuration is generated based on the first information,
wherein the transceiver is configured to receive, from the DU, the hybrid BF configuration,
wherein the hybrid BF configuration includes control bit vectors for phase-shifters, and
wherein a control bit vector, from the control bit vectors, is mapped to a phase value, an in-phase (I) value and a quadrature (Q) value.

16. The RU of claim 15, wherein the hybrid BF configuration includes an analog BF configuration that applies to a frequency band and a digital BF configuration that applies to a subband within the frequency band.

17. The RU of claim 15, wherein a control message comprises:
a tdBfParamPhase field indicating the control bit vector,
a disableDigBeamId field indicating whether digital beam identifiers (IDs) are disabled, and
a disableAnaBeamId field indicating whether analog bean IDs are disabled,
wherein the tdBfParamPhase field is 4 bits, and
wherein the transceiver is configured to receive the control message.

18. The RU of claim 15, wherein the transceiver is configured to transmit, to the DU, second information indicating capabilities related to beamforming, wherein the second information includes a minimum supported delay, a supported delay resolution, and a supported maximum number of beams,
wherein the controller is configured to determine, based on the second information, parameters related to BF, wherein the parameters include third information related to a number of delay elements, bit resolution of the delay elements, bit width of the delay elements, a minimum delay, and a maximum number of beams, and
wherein the transceiver is configured to transmit the parameters for BF.

19. The RU of claim 18, wherein a control message comprises:
a section extension type field indicating a section extension type used for the parameters for beamforming,
a disableBFWs field indicating whether the parameters for beamforming are explicitly indicated,
a numBundPrb field indicating a number of physical resource blocks (PRBs) in each PRB bundle,
a symbolMask field indicating a bit mask that indicates whether the section extension type is applicable to a symbol in a slot,
a tdbfParamDelay field indicating a delay at each of the delay elements,
a tdbfParamPhase field indicating a phase at each phase shifter, and
a bfw field indicating beamforming weights for each of the PRB bundle, and
wherein the transceiver is configured to receive the control message.

20. The RU of claim 15, wherein the hybrid BF configuration include a section extension X (SE-X) and a digital BF configuration.
